(19) United States
(12) Patent Application Publication
(10) Pub. No.: US 2008/0179311 A1
(43) Pub. Date: Jul. 31, 2008

(54) INFANT FEEDING SYSTEM

(76) Inventors: Fuat Koro, Arlington, MA (US); John G. Brooks, Westborough, MA (US); Richard Alan Patterson, Georgetown, TX (US)

Correspondence Address: FISH & RICHARDSON PC, P.O. BOX 1022, MINNEAPOLIS, MN, 55440-1022, US

(21) Appl. No.: 11/627,135

(22) Filed: Jan. 25, 2007

(51) Int. Cl. A47J 36/24

(52) U.S. Cl. 219/430

(57) ABSTRACT

An apparatus for heating a liquid is described. The apparatus includes a housing. A liquid reservoir is contained within the housing. A fluid circuit conveys liquid from the reservoir to a dispenser. A thermal energy storage unit is contained within the housing and disposed to be in thermal contact with the fluid circuit. The thermal energy storage unit is constructed and arranged to heat liquid as it passes through the fluid circuit. The thermal energy storage unit can include a phase change material or a combination of a phase change material and a high thermal conductivity material.

### BACKGROUND OF THE TECHNOLOGY

Conventional baby bottles require external warming devices to heat the contents of the bottle. For example, one technique for warming the contents of the bottle includes immersing the bottle in hot water. Other techniques include warming the contents in a microwave oven, or warming the contents in an electric bottle warmer. Most conventional baby bottle warmers overheat the liquid contents due to an inability of the device to account for factors such as liquid feed storage temperature, amount of the liquid contents, and the amount of water to be used in heating. Warming the liquid contents in a microwave oven can cause the liquid contents to heat unevenly, creating undesirable “hot spots” in the liquid contents.

### SUMMARY OF THE INVENTION

In one aspect, an apparatus for heating a liquid includes a housing. A liquid reservoir is contained within the housing. A fluid circuit conveys liquid from the reservoir to a dispenser. A thermal energy storage unit is contained within the housing and disposed to be in thermal contact with the fluid circuit. The thermal energy storage unit is constructed and arranged to heat liquid as it passes through the fluid circuit. The thermal energy storage unit can include a phase change material or a combination of a phase change material and a high thermal conductivity material. In one embodiment the phase change material is disposed within a matrix of a high thermal conductivity material. The phase change material can have a phase transition temperature within five degrees C. of human body temperature.

In one embodiment, the fluid passes through the fluid circuit on demand. The fluid circuit can be disposed on the outer surface of the thermal energy storage unit. In one embodiment, the fluid circuit consists of a plurality of separate fluid circuits disposed on the outer surface of the thermal energy storage unit. The fluid circuit can include a continuous helical groove disposed in part along the thermal energy storage unit. In one embodiment, the fluid circuit is located at least partially within the thermal energy storage unit.

In one embodiment, the thermal energy storage unit can be decoupled from the apparatus for charging. The liquid reservoir can include a removable liner that is rigid or collapsible.

In one embodiment, the housing can be divided into two sections. The first section includes the thermal energy storage unit for heating fluid to a desired operating temperature. The second section includes the fluid reservoir for holding fluid prior to being heated by the thermal energy storage unit. The second section can be thermally isolated from the first section.

In one aspect, a method of heating a fluid within a feeding system includes containing fluid within a fluid reservoir. The method also includes drawing the fluid through a fluid circuit. The fluid within the fluid circuit is in thermal contact with a thermal energy storage unit. Heat from the thermal energy storage unit is conducted to the fluid to heat the fluid.

In one embodiment, the fluid is heated substantially on demand. The act of conducting heat includes raising the temperature of the fluid to a desired operating temperature. The desired operating temperature cart be within approximately five degrees Celsius of normal human body temperature.

The fluid circuit can be disposed on the outer surface of the thermal energy storage unit. The thermal energy storage unit can be charged to its operating temperature prior to feeding. The fluid reservoir can include a rigid finer or a collapsible liner.

The thermal energy storage unit can include a phase change material. The thermal energy storage unit can also include a combination of a phase change material and a high, thermal conductivity material.

In another aspect, an apparatus for heating a liquid includes a housing. A liquid reservoir is contained within the housing. A first fluid circuit conveys liquid from the reservoir to a dispenser. A heat source is in thermal contact with the fluid circuit. The heat source can include a thermal energy storage unit. The apparatus also includes a priming system. The priming system evacuates gas from the first fluid circuit through a second fluid circuit when the apparatus is in an inverted position.

The apparatus can also include a vacuum management system to reduce the creation of voids when liquid is drawn down from the reservoir. The vacuum management system can also include a third fluid circuit and a flow control mechanism. The flow control mechanism allows air to enter the reservoir through the third fluid circuit to reduce vacuum that would otherwise occur as liquid is drawn down.

The priming system can also include a flow control mechanism that permits gas to discharge through the second fluid circuit. The second fluid circuit can originate in proximity to the fluid dispenser and discharges gas into the reservoir. In one embodiment, the second fluid circuit originates in proximity to the fluid dispenser and discharges gas outside of the apparatus.

The apparatus can also include a valve that controls the flow of liquid from the reservoir to the fluid circuit. The valve prevents liquid from flowing from the fluid circuit to the reservoir section. In one embodiment, drawing liquid through the fluid circuit causes the reservoir to collapse such that substantially no vacuum space is created by voiding the liquid. In one embodiment, the priming system further includes collapsing the reservoir to squeeze air out of the fluid circuit.

In one aspect, a method for heating a fluid within a feeding system includes conveying liquid from a fluid reservoir through a first fluid circuit to a liquid dispenser. The method also includes heating the liquid in the first fluid circuit and evacuating air bubbles in the first fluid circuit through a second fluid circuit.

In one embodiment, the method also includes step of replacing liquid drained from the reservoir with air by allowing air to flow into the reservoir through a third fluid circuit. The method can also include collapsing a reservoir liner disposed within the fluid reservoir to expel liquid contained within the reservoir through the first fluid circuit to a liquid dispenser. In one embodiment, collapsing the reservoir liner further includes displacing a first concentric shell containing the reservoir relative to a second concentric shell attached to the dispenser. In other embodiments, the reservoir liner is collapsed by gravity or suction.

In one embodiment, air bubbles are evacuated through the second fluid circuit into the fluid reservoir. The flow of fluid from the reservoir to the second fluid circuit can be prevented by a flow restriction device. In one embodiment, air passing from the first fluid circuit through the second fluid circuit is evacuated to the outside. The flow of outside air into the feeding system through the second fluid circuit can be prevented by a flow restriction device. A flow restriction device can prevent the flow of liquid from the reservoir through the third fluid circuit.

In one aspect, a charging station for a thermal energy storage unit of a liquid feeding system includes a heating pad for supplying heat energy to the thermal energy storage unit. A power supply is coupled to the heating pad. The power supply provides energy to the heating pad. A base contains the power supply. In one embodiment, the base includes a mating thread that mates with a thread on a housing of an infant feeding system.

A controller can be coupled to the power supply. The controller can include a temperature controller for determining when the thermal energy storage unit is fully charged. The thermal energy storage unit can include a phase change material. The controller determines when the phase change material in the thermal energy storage unit has reached a liquid state.

### BRIEF DESCRIPTION OF THE DRAWINGS

This invention is described with particularity in the detailed description. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a component view of one embodiment of an infant feeding system.

FIG. 2 illustrates an exploded view of the infant feeding system of FIG. 1.

FIG. 3 illustrates a cross-sectional view of one embodiment of a thermal energy storage unit.

FIG. 4 illustrates the infant feeding system of FIG. 1 in an assembled state.

FIG. 5 illustrates a cross-sectional view of the infant feeding system of FIG. 4.

FIG. 6 illustrates a cross-sectional view of the flow path across the thermal energy storage unit in the infant feeding system of FIG. 4.

FIG. 7 illustrates a drop-in module for use with a shell in the infant feeding system of FIG. 4.

FIG. 8 is a perspective view of one embodiment of a thermal energy storage unit.

FIG. 9 illustrates the assembly of the drop-in module and the shell according to one embodiment.

FIG. 10 illustrates a cross-sectional view of the drop-in module and the shell of FIG. 9.

FIG. 11 illustrates a cross-sectional view of one embodiment of the infant feeding system.

FIG. 12A, FIG. 12B, and FIG. 12C illustrate various thermal energy storage units.

FIG. 13 illustrates one embodiment of a liner for use with the infant feeding system.

FIG. 14 illustrates the assembly of a thermal energy storage unit and the liner of FIG. 13.

FIG. 15 illustrates a cross-sectional view of the assembly of a thermal energy storage unit and the liner of FIG. 13.

FIG. 16 illustrates a cross-sectional view of one embodiment of an infant feeding system.

FIG. 17A and FIG. 17B illustrate one embodiment of a valve for use in the infant feeding system of FIG. 16.

FIG. 18A, FIG, 18B, and FIG. 18C illustrate one embodiment of a priming technique for the infant feeding system.

FIG. 19A and FIG. 19B illustrate another embodiment of a priming technique for the infant feeding system.

FIG. 20 illustrates one embodiment of a shell for an infant feeding system.

FIG. 21 illustrates one embodiment of a thermal energy storage unit for an infant feeding system.

FIG. 22 illustrates one embodiment of a thermal energy storage unit.

FIG. 23 illustrates a cross-sectional view of a charging device for use with the infant feeding system.

FIG. 24 illustrates an external view of a charging device for use with the infant feeding system.

FIG. 25 illustrates a cross-sectional view of the charging device of FIG. 24.

FIG. 26 is a graph of temperature versus time during a charging cycle for a thermal energy storage unit.

FIG. 27 illustrates a thermal energy storage unit having an internal resistive heating element with terminals that can be coupled to an external power source.

FIG. 28 illustrates an assembly view of another embodiment of an infant feeding system.

FIG. 29 illustrates an example of a flow path described by the frame shown in FIG. 28.

FIG. 30 illustrates a method of assembly of the infant feeding system of FIG. 28.

FIG. 31 is a cut-away view of the assembled infant feeding system of FIG. 28.

FIG. 32 illustrates another embodiment of an infant feeding system.

FIG. 33 illustrates the liquid container of FIG. 32.

FIG. 34 illustrates the components of the infant feeding system of FIG. 32.

FIG. 35 illustrates a priming mechanism which can be used with the infant feeding system of FIG. 32.

FIG. 36 illustrates a more detailed diagram of the priming mechanism of FIG. 35.

FIG. 37 illustrates another priming mechanism for the infant feeding system of FIG. 32.

FIG. 38 is a detail of the priming mechanism of FIG. 37.

FIG. 39 illustrates a TESU being assembled into a nipple/sleeve assembly according to one embodiment.

FIG. 40 illustrates a charging station for use with the nipple/sleeve assembly of FIG. 39.

FIG. 41 is a cut-away view of the charging station of FIG. 40.

FIG. 42 illustrates one embodiment of an infant feeding system.

### DETAILED DESCRIPTION

The present disclosure relates to a device that allows liquids feeds such as (but not limited to) formula and breast milk to be heated to a temperature that is desirable to the infant. The feeding assembly has an integrated warmer that obviates the need for preheating the liquid feed. The warmer provides a fast heating means that eliminates the risk of overheating the liquid feed. Some embodiments of the feeding assembly also include a charging station that can sanitize reusable items of the assembly.

In one aspect, an infant feeding system according to one embodiment provides on-demand heating of the liquid feed. By on-demand, we mean that only the liquid feed that is actually consumed is heated, while the bulk of the liquid feed remains at its initial temperature in an attached reservoir. Thus, only a small portion of the liquid feed is heated at any moment during the actual feeding. The liquid feed is heated using a thermal energy storage unit (TESU). The TESU acts as a simple thermal reservoir via its physical heat capacity. The TESU is a passive device that stores heat energy, it does not generate its own heat, and does not use active heating elements to heat liquid feed.

The TESU may be removed from the feeding system and charged externally by a separate heater such as a resistive element, induction heater, or heat exchanger. Once charged to its operating temperature, ideally close to human body temperature (e.g., ideally within 5 degrees Celsius of normal body temperature), when placed in the infant feeding system the TESU discharges heat through conductive heat transfer to the liquid feed. For example, the TESU conducts heat thereby raising the temperature of the liquid feed to a desired operating temperature. A TESU could contain an active heating element, but it would only be used to charge the TESU when it was not being used to heat liquid feed. For example, the TESU could be removed and plugged into a power supply, where the heating element within the TESU would be powered by the external power supply to charge the TESU to its operating temperature.

The functionality of the thermal energy storage unit is enhanced by including a material with a large heat capacity at or near the operating temperature. One material with a heat capacity that can be tuned through precise selection to be large at the operating temperature is a phase change material (PCM). Such a material with a phase transition near the operating temperature has a large latent heat of fusion thus can absorb considerable heat when brought to the operating temperature. Wax materials can be designed to have phase transition temperatures in the desired region, and have a large latent heat of fusion. In one embodiment, the phase change material has a phase transition temperature within five degrees Celsius of normal human body temperature.

In one embodiment, the infant feeding system is capable of rapidly warming a liquid feed on-demand, from its storage temperature to a temperature range that is desirable to the infant. The integrated warmer maintains the liquid in the desired temperature range during the course of a typical feeding period. Typical refrigerator storage temperatures range from 1.7° C. (35° F.) to 4.4° C. (40° F.). Alternatively, liquid feeds such as formula can be prepared at indoor temperatures that typically range from 20° C. to 25° C. prior to feeding the infant.

In some embodiments, an infant feeding system has both a priming mechanism to aid the start of fluid flow, and vacuum management to further improve fluid flow. The priming mechanism removes trapped, air bubbles that can block fluid flow and reduces the amount of air that a feeding infant can ingest. In one embodiment, the priming system evacuates gas from the fluid circuit when the feeding system is in an inverted position. In one embodiment, the priming system can include a flow control mechanism, such as a valve that permits air to be discharged through a separate fluid circuit. The separate fluid circuit can be located proximate to the nipple or fluid dispenser and can discharge the air into the reservoir.

An optional vacuum management system inhibits the creation of voids in the system when a feeding infant draws down the liquid in the reservoir. In some embodiments, a collapsible liner shrinks as liquid is drawn, to avoid the creation of a vacuum space. In some embodiments, the fluid is contained by a rigid shell, and a check valve is provided that admits air to replace withdrawn liquid, while preventing liquid from escaping inadvertently. In one embodiment a vacuum management system can include a flow control mechanism such as a valve. The flow control mechanism allows air to enter the reservoir to reduce the existence of vacuum that could inhibit the flow of liquid from the reservoir as the liquid is drawn down.

To provide rapid heating for only the liquid that is being consumed, a fluid circuit transports liquid from the reservoir to a dispenser, such as a nipple or feeding spout. The fluid circuit provides a flow path for the liquid. The volume of liquid in the fluid circuit is small compared to the total capacity of the reservoir. This fluid circuit is in close thermal contact with the TESU. The TESU transfers heat to the liquid in the fluid circuit. One or more fluid circuits can be disposed on the outer surface of the TESU. In some embodiments, one or more fluid circuits can be located partially or completely within the TESU.

Trapped air can exist within a feeding system. If this air exits through the fluid dispenser or (e.g. the nipple), the infant can ingest the trapped air causing discomfort. In some embodiments, a priming mechanism is incorporated to remove trapped air from the liquid circuit. In embodiments where the fluid is contained by a flexible reservoir, priming is achieved by mechanical squeezing of the liner by a caregiver prior to feeding, forcing fluid into the constricted fluid circuit, thus displacing the air that would otherwise block fluid flow. In embodiments where the fluid is contained within a rigid reservoir, a valve permits air to escape, providing an alternate path for air flow and avoiding air flow through the nipple. Thus in the hard shell embodiment there are at least two valves: one for priming and another for vacuum management.

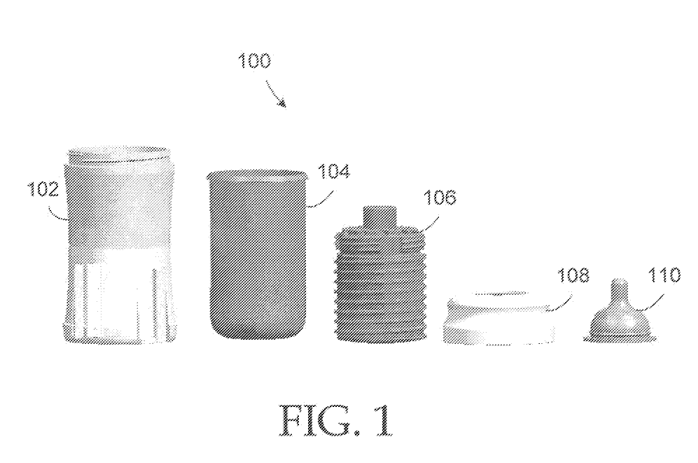

FIG. 1 illustrates a component view of one embodiment of an infant feeding system 100. The infant feeding system 100 includes a shell 102, a liner 104, a thermal energy storage unit 106, a ring 108, and a nipple 110. The liner 104 can be rigid or collapsible. Additionally, the liner 104 can be reusable or disposable.

The shell 102 is used to support the liner 104 and the thermal energy storage unit 106. The nipple 110 fits into the ring 108 and the ring 108 is coupled to the shell 102. In one embodiment, the ring 108 is threaded onto the shell 102.

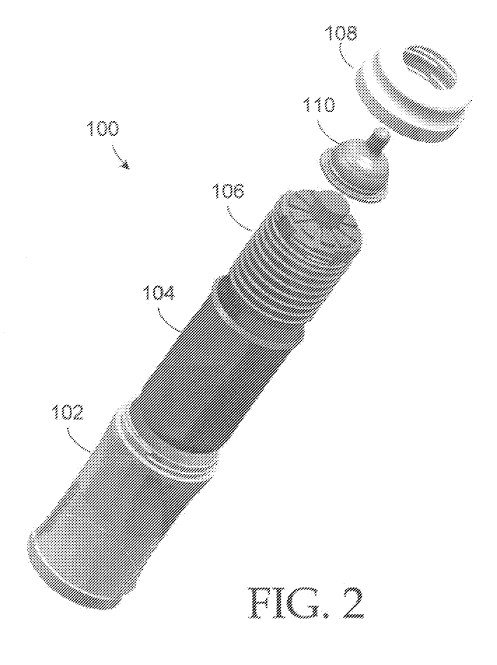

FIG. 2 illustrates an exploded view of the infant feeding system 100 of FIG. 1. The thermal energy storage unit (TESU) 106 serves as the heat source used in elevating the temperature of the liquid from its initial temperature to the temperature range desired by the infant. The TESU 106 contains a phase change material (PCM) that provides a means to store a large quantity of energy in the latent heat of fusion. Some thermal energy is also stored as sensible heat in the materials that make up the TESU 106. By sensible heat we mean the heat which increases the temperature of a body to which it is added. By latent heat, we mean heat that is related to energy stored in the phase change material without a change in temperature. In other words, the thermal capacitance of the TESU 106 also contributes to total energy stored. However, a large majority of the energy required to heat the liquid feed is stored in the latent heat of fusion of the PCM.

Prior to the feeding of the infant, the TESU 106 is charged in a charging station to elevate its temperature to a level above the melting temperature of the PCM. Accordingly, the PCM is in a liquid state at the onset of feeding. The phase transitions are reversible and the same TESU 106 can be used throughout the life of the feeding system 100 by heating it above its melting temperature prior to feeding.

There are three general classes of PCMs that can effectively be used in the TESU 106. These include paraffins, salt-hydrates, and nonparaffin organics. Any number of phase-change materials can be used in the TESU 106. For example, the following selection criteria can be employed in identifying the PCM material for this application;
Toxicity, Corrosiveness
Cost
Useful life
Latent heat of fusion
Phase change Temperature
Congruent freezing (by congruent freezing, we mean that the phase change occurs in a narrow temperature band)

Other selection criteria could also be used.

One phase change material used in the TESU 106 is a paraffin-based wax. Paraffin waxes can be favorable for this application since they are nontoxic; do not deteriorate as a result of undergoing thermal cycling; are available at a low cost; have a high latent heat of fusion; and their phase transition temperature can be selected over a fairly wide range.

Typical PCMs suffer from a low thermal conductivity. Therefore, even though heat can be stored efficiently, the stored heat may not be accessible when a large flux density is required. This shortcoming can be addressed by integrating a thermal conductivity enhancing material into the TESU 106. In one implementation, a high-thermal-conductivity matrix material is impregnated with the PCM to facilitate the heat transfer. The matrix material can be constructed using various solutions. Some potential solutions can include:
Porous open-cell foams that are made using a high-conductivity base material such as graphite, aluminum, copper
Metallic Fins
Sintered metals
Cellular structures fabricated from sheet metal such as Aluminum Honeycomb and Corrugated aluminum spirals
Stacked wire meshes
Doping Materials

In one embodiment, an integrated metal/PCM composite can have a significantly higher thermal conductivity than a pure PCM. Any of the various thermal conductivity enhancers mentioned above can be used alone or in combination. In terms of the selection the main factors considered are:
Effective bulk thermal conductivity
Porosity/Relative density
Cost
Assembly

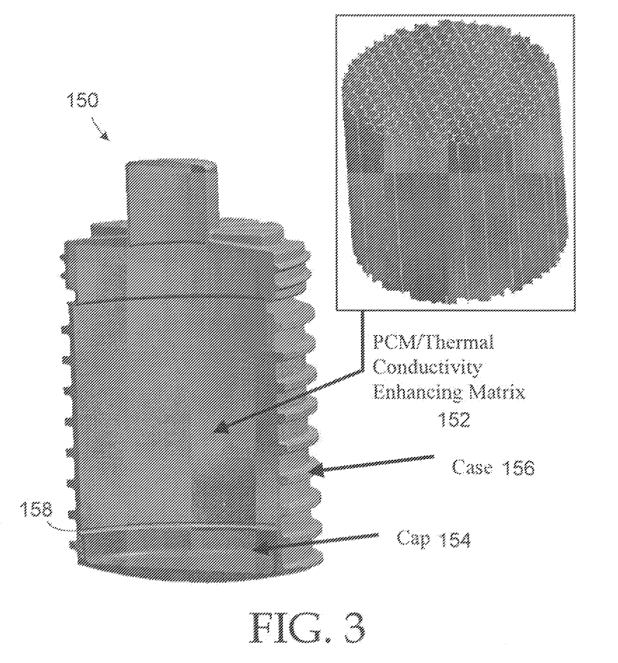

FIG. 3 illustrates a cross-sectional view of one embodiment of a thermal energy storage unit 150. During manufacturing assembly, the interior of the case 156 is fitted with a thermal conductivity-enhancing matrix 152. Subsequently, the PCM is impregnated into the matrix to create a composite interior that has high thermal conductivity. Finally, the cap 154 is attached to the case 156 and sealed. The seal 158 between the cap 154 and the case 156 prevents the composite PCM from leaking out of the case 156. The seal 158 also prevents air and moisture from entering the case 156, which can potentially cause oxidation and related degradation of the paraffin. The seal 158 is preferably a permanent hermetic seal such as those produced by hermetic laser welding.

In one embodiment, the feeding system provides a heating solution that eliminates the risk of overheating the liquid feed. PCMs are essentially self-regulating with respect to temperature and exhibit an almost isothermal phase change without the need for any type of external control for temperature regulation. Accordingly, by setting the melting point of the phase change material to a predetermined temperature, for example, a temperature that is below the discomfort level, of the infant, the feeding system eliminates health risks associated with overheating the liquid.

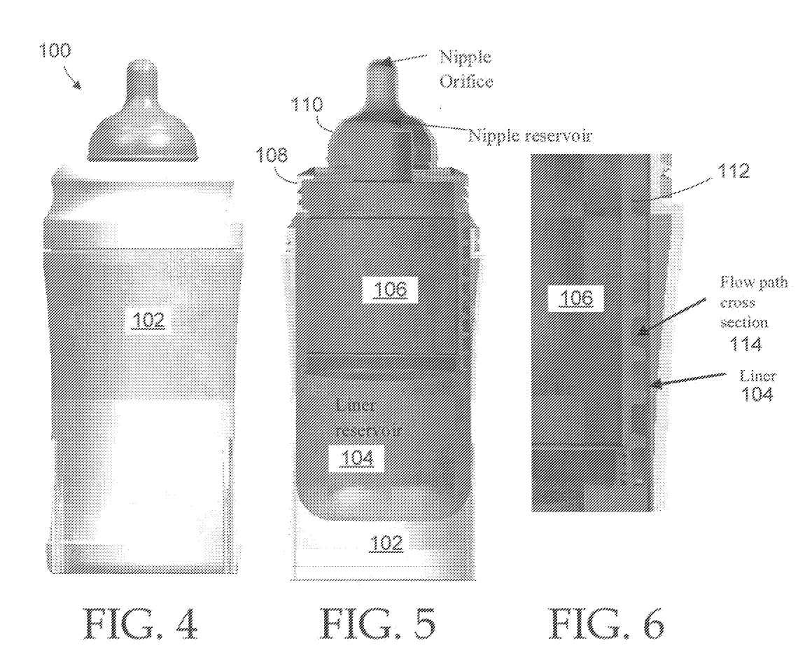

FIG. 4 illustrates the infant feeding system 100 of FIG. 1 in an assembled state. The shell 102 of the system 100 can be economically designed to allow a caregiver and/or an infant to comfortably hold the shell 102. Additionally, the color and/or translucence of the shell can be modified as desired.

FIG. 5 illustrates a cross-sectional view of the infant feeding system 100 of FIG. 4. The liner 104 is positioned inside the shell 102. The TESU 106 is positioned inside the liner 104. The ring 108 secures the nipple 110 to the shell 102. The ring 108 also provides a mechanical lock to create a liquid-tight seal between the edge of the liner 104 and the nipple 110.

FIG. 6 illustrates a cross-sectional view of the thermal energy storage unit (TESU) 106 in the infant feeding system 100 of FIG. 4. The heat transfer between the TESU 106 and the liquid feed can take place in various heat exchanger configurations. In general, increasing the surface area of the TESU 106 that is in contact with the liquid feed increases the heat exchanged between the TESU 106 and the liquid feed. In one embodiment the heat exchanger configuration includes a fluid circuit in the form of a helical groove 112 disposed on the outside of the TESU 106. A closed-flow path 114 of the fluid circuit is formed when the TESU 106 is inserted into the liner 104. The inner diameter of the liner 104 and the outer diameter of the TESU 106 are dimensioned such that a tight fit is formed when these two parts are disposed coaxially. Accordingly, when the liner 104 and TESU 106 are engaged as shown in FIG. 4, a closed fluid circuit or conduit is formed between the two mating parts. As the liquid travels in this fluid conduit due to the suction of the infant, heat is transferred from the walls of the TESU 106 to the liquid. A close-up of the flow path geometry is shown in FIG. 6. Heat transfer between the liquid and the TESU 106 lakes place primarily in the flow path 114. However, heat can also be transferred across any other area of the TESU 106 that contacts the liquid.

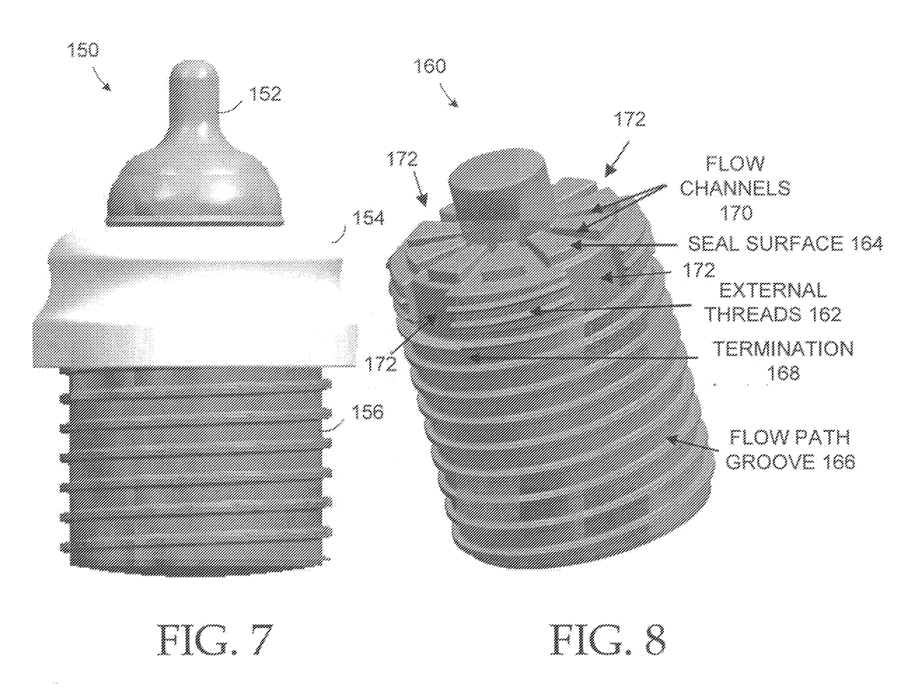

FIG. 7 illustrates a drop-in module 150 for use with the shell 102 in the infant feeding system 100 of FIG. 4. In one embodiment, the nipple 152, ring 154 and the TESU 156 are assembled to form the drop-in module 150 as shown in FIG. 7. The drop-in module 150 can be placed in a charging station (not shown) as a subassembly. The components that make up the drop-in module 150 are reusable parts that come into contact with the liquid during the feed. Thus, the components can be sanitized before they are re-used for feeding.

In one embodiment, the drop-in module 150 is assembled in two steps. First, the nipple 152 is inserted, and seated coaxially in the ring 154. The nipple 152 is a compliant member and the ring 154 includes a hole to accommodate the nipple 152. The nipple 152 preferably has a circumferential protrusion that acts as a retention feature. In one embodiment, the nipple 152 is secured in the ring 154 by positioning the protrusion through the ring 154. In a second step, the ring 154 is threaded onto the TESU 156.

FIG. 8 is a perspective view of one embodiment of a thermal energy storage unit (TESU) 160. The TESU 160 includes external threads 162 and the ring 154 (FIG. 7) has internal threads for engagement in this particular embodiment. Other methods of coupling the TESU 160 and the ring 154 are also possible. In one embodiment, as the TESU 160 is threaded into the ring 154, the bottom surface of the nipple 152 (FIG. 7) is compressed and an axial load is generated between the seal surface 164 of the TESU 160 and the nipple 152. This particular engagement between the TESU 160 and the ring 154 allows a face seal to be formed between the nipple 152 and the ring 154, thereby preventing liquid leaks.

A groove 166 formed in the outer surface of the TESU 160 provides a flow path or fluid circuit for the liquid. The termination 168 of the groove 166 that contains the liquid is also shown. The primary face seal area for the TESU 160 is formed from a plurality of seal surfaces 164 that include radially extending flow channels 170. These flow channels 170 allow liquid to flow into the nipple 152. Likewise, the external, helical threads 162 on the TESU 160 are discontinuous to allow the liquid to flow through four separate zones 172 as shown in FIG. 8. After each feeding, the drop-in module 150 of FIG. 7 is disassembled, washed, reassembled and placed into a charging station (not shown) to prepare for the next feed.

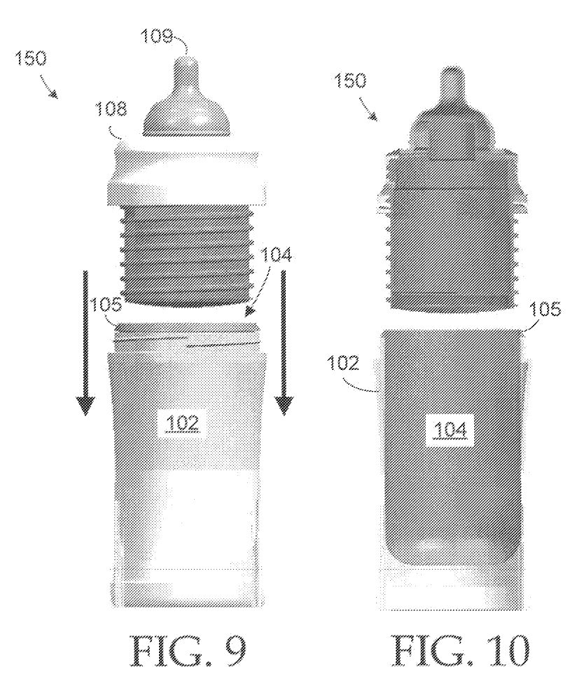

FIG. 9 illustrates the assembly of the drop-in module 150 and the shell 102 (FIG. 1). For example, in a typical feeding session, the preparation involves five steps. First, a pre-sanitized liner 104 is inserted into the shell 102 which is a hollow structure. The liner 104 has a lip feature 105 at the top that secures it to the shell 102. Second, the liner 104 is filled with the liquid feed. Third, the drop-in module 150 is removed from the charging station (not shown) and inserted into the liner 104. The drop-in module 150 is secured to the shell 102 using a threaded connection. This threaded, connection also helps to form a seal between the liner 104 and the ring 108 by providing the appropriate level of loading. Finally, any air in the system 100 is evacuated by collapsing the liner 104 until liquid flows from the small nipple orifice 109. The liner 104 can be collapsed by manually forcing air out of it. The air escapes through the nipple orifice 109. Alternatively, the liner 104 can be collapsed automatically using a technique described herein. In one embodiment, the reservoir liner collapses when the liquid is drawn through the fluid circuit such that no vacuum space is created by voiding the liquid.

FIG. 10 illustrates a cross-sectional view of the drop-in module 150 and the shell 102 of FIG. 9. As previously described, the drop-in module 150 fits into the liner 104 which is supported by the shell 102.

A feeding system according to one embodiment provides on-demand feeding while minimizing the number of additional parts and associated complexity compared with traditional feeding systems. In one embodiment, as shown in FIG. 10, the drop-in module 150 includes an additional component (i.e., the TESU 160 (FIG. 8)) as compared to a conventional feeding system. Additionally, assembling the feeding system does not require any complicated steps that deviate from assembling existing feeding systems and that can lengthen the time of preparation of the feed.

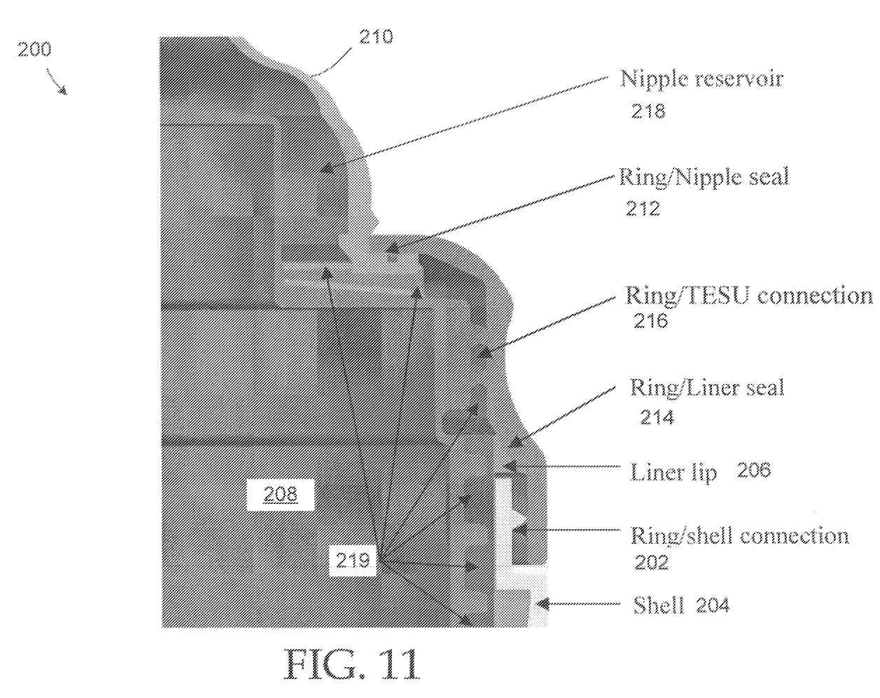

FIG. 11 illustrates a cross-sectional view of the top of an infant feeding system 200. Specifically, FIG. 11 is a detailed cross-sectional view illustrating how five components (202, 204, 206, 208, and 210) interface with each other. The ring 202 is the central piece that interfaces with the shell 204, the liner 206, the TESU 208, and the nipple 210. In this embodiment, there are two sealing interfaces. The interfaces include the ring/nipple interface 212 and the ring/liner interface 214. Also shown for illustrative purposes are the ring/TESU interface 216 and the nipple reservoir 218. In order to reach the nipple reservoir 218, the liquid feed flows along a flow path 219 to the nipple reservoir 218. The TESU 208 can include certain features illustrated in FIG. 8 that allow the liquid feed to flow past the ring/TESU interface 216 and the ring/nipple interface 212.

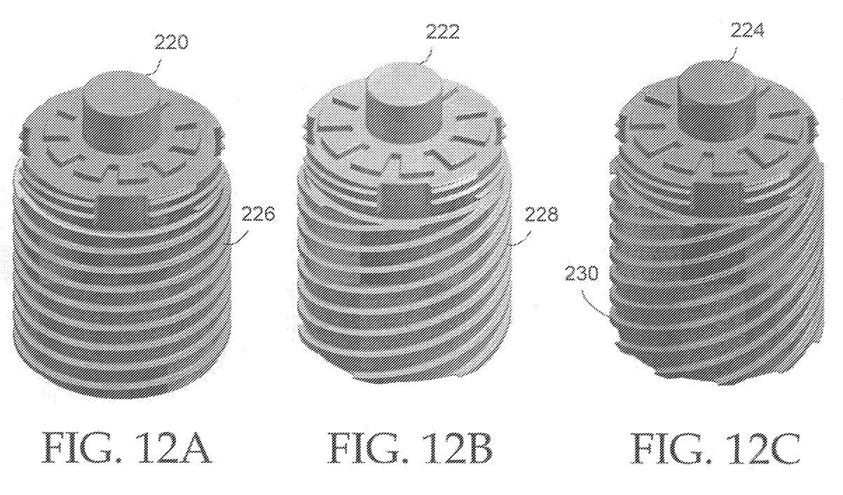

FIG. 12A, FIG. 12B, and FIG. 12C illustrate various embodiments of thermal energy storage units 220, 222, and 224. As previously described, the heat transfer between the TESU and the liquid feed can take place in various heat exchanger configurations. Other potential heat exchange solutions can incorporate multiple flow paths that can be helical or straight as shown in FIG. 12A-FIG. 12C.

For example. FIG. 12A illustrates a TESU 220 having a single fluid circuit 226. FIG. 12B illustrates a TESU 222 having six fluid circuits 228. FIG. 12C illustrates a TESU 224 having ten fluid circuits 230.

One feature of a TESU having multiple fluid circuits is that the multiple fluid circuits reduce the pressure drop across the heat exchanger. This is desirable since it assures that the liquid in the nipple reservoir 218 (FIG. 11) can be replenished easily from the liner reservoir (not shown). This also eliminates the formation of a partial vacuum in the nipple reservoir 218 that could result in air entering through the small nipple orifice and forming bubbles. Another advantage of minimizing the pressure drop across the heat exchanger is that it results in easier priming (evacuation of the air) prior to feeding.

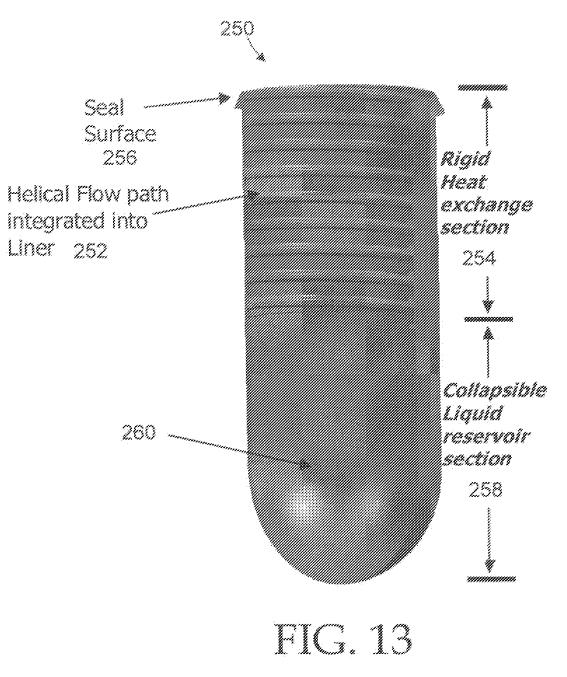

FIG. 13 illustrates one embodiment of a liner 250 for use with the infant feeding system. In this embodiment, the liner 250 includes flowpath grooves 252. The grooves 252 can be formed in the liner 250 during the liner manufacturing process using known manufacturing techniques. For example, the liner 250 can be manufactured using blow-molding or thermoforming techniques. In one embodiment, the liner 250 can include two sections. The top section 254 is rigid and forms the fluid circuit when the TESU is placed inside the liner 250. The top section 254 also includes a seal surface 256. The bottom section 258 includes a collapsible liquid reservoir 260 that contains the liquid feed. Atmospheric pressure collapses the bottom section 258 as the infant draws liquid from the small nipple orifice.

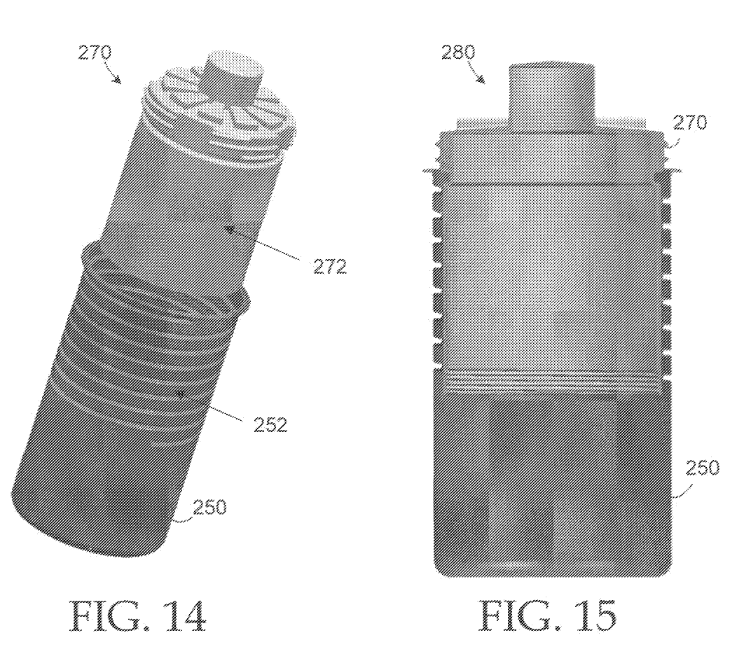

FIG. 14 illustrates the assembly of a thermal energy storage unit 270 and the liner 250 of FIG. 13. The surface 272 of the TESU 270 is substantially smooth. The liner 250 incorporates grooves 252. The grooves 252 create the fluid circuit for the liquid feed.

FIG. 15 illustrates a cross-sectional view of the assembly 280 of a thermal energy storage unit 270 and the liner 250 of FIG. 14 in one embodiment, the liner 250 fits snugly against the TESU 270, thereby preventing liquid feed from escaping from the fluid circuit.

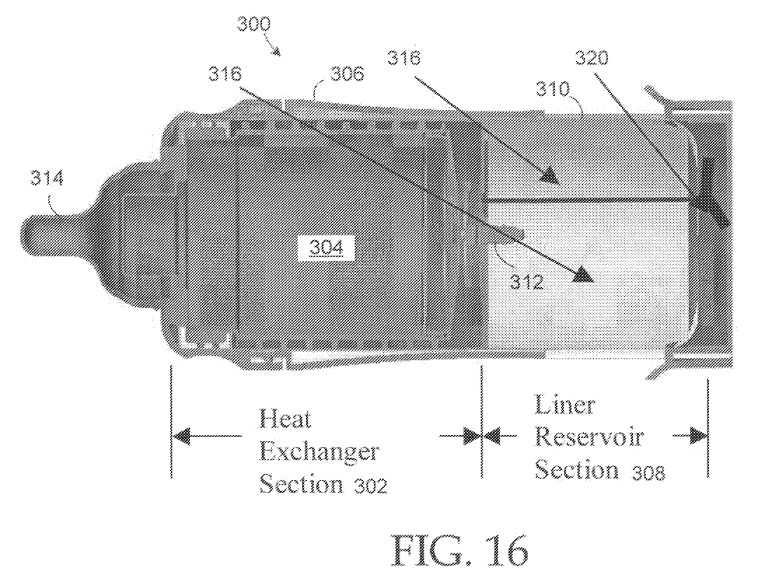

FIG. 16 illustrates a cross-sectional view of one embodiment of an infant feeding system 300. The infant feeding system 300 includes a heat exchanger section 302 that includes a TESU 304 positioned inside a shell 306. A liner reservoir section 308 includes a liner 310 that contains the liquid feed. The liner 310 can be rigid or can be collapsible. In one embodiment, the reservoir section 308 is thermally isolated from the heat exchanger section 302. A flow control mechanism such as a valve 312 is positioned between the heat, exchanger section 302 and the liner reservoir section 308. For example, the valve 312 can be an orientation dependent flow control mechanism. The valve 312 can include a one-way valve that allows liquid to flow from the liner reservoir section 308 to the heat exchanger section 302 while preventing the liquid from flowing in the opposite direction. For example, the valve 312 can be a gravity-activated valve that operates in response to the orientation of the system. Other valves can also be used. A nipple 314 is coupled to the heat exchanger section 302.

As previously described, one feature of the infant feeding system 300 is that liquid is heated on-demand. That is, the bulk liquid 316 is not heated prior to the feed. The liquid In the liner 310 remains close to the storage temperature until it enters the fluid circuit of the heat exchanger section 302. This provides a means to reduce the waste of unused liquid feed. The liquid feed conservation functionality is detailed herein. In one embodiment, unused liquid feed can be recovered through an opening 320 in the liner reservoir section 308.

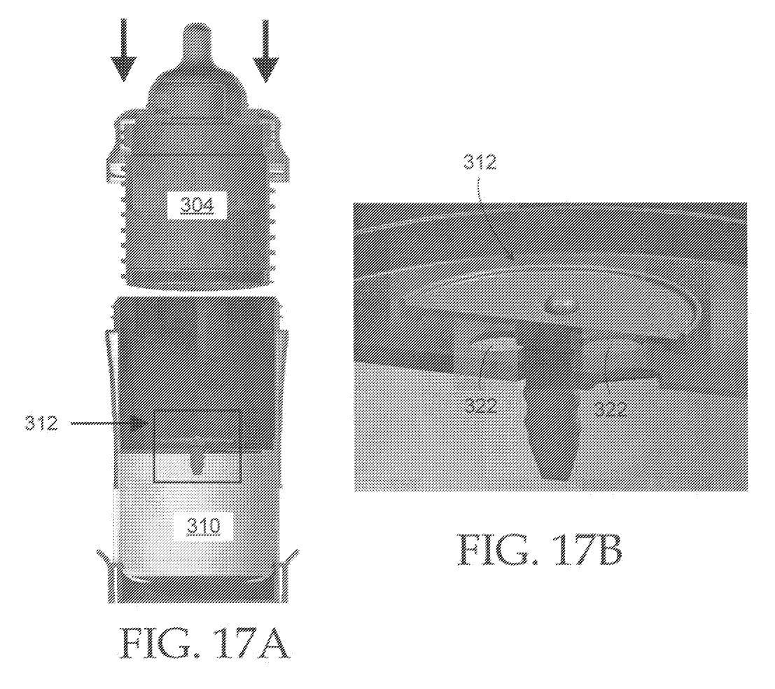

FIG. 17A and FIG. 17B illustrate one embodiment of a valve 312 for use in the infant feeding system 300 of FIG. 16. The heat exchanger section 302 of the infant feeding system 300 houses the TESU 304. The heat exchanger section 302 can include a rigid liner or a flexible liner. The liquid from the liner reservoir 310 flows into the heat exchanger section 302 (FIG. 16) through a plurality of orifices 322. In one embodiment, an orientation dependent flow control mechanism is implemented as a gravity-actuated disk valve that is incorporated into the infant feeding system 300 between the heat exchanger section 302 and the liner reservoir section 308.

The gravity-actuated disk valve is a translating member that seals the heat exchange section 302 from the liquid reservoir section 308 based on the orientation of the infant feeding system 300. The valve 312 transitions from open to closed mode as the orientation of the system 300 changes and the liquid in the heat exchange section 302 (FIG. 16) flows into the liquid reservoir section 308 due to the force of gravity. Accordingly, the valve 312 acts as a non-return valve that prevents warm liquid from flowing back into the liner reservoir 310.

In one embodiment, any unused liquid can be saved by opening an end of the liner reservoir 310 using a peel-off feature 320 (FIG. 16) that is incorporated in the bottom of the liner reservoir 310.

In other embodiments, multiple liners can be used. For example, one liner can contain refrigerated liquid feed and the other liner can contain liquid feed having a desired temperature. One or both of the liners can he flexible or rigid.

The non-return valve 312 used in the embodiment of FIG. 17A and FIG. 17B is a gravity-actuated disk valve. However, a similar non-return mechanism can be constructed using different valve architectures such as a duckbill valve, a flapper valve, a poppet valve or a pinch valve, for example.

A flow restriction device (not shown), such as a valve can he coupled to the reservoir. The flow restriction device substantially prevents the flow of fluid from the reservoir to an outside vent in one embodiment, air passes from the fluid circuit to the outside vent where it is evacuated outside of the feeding system. In one embodiment, the flow restriction device is adapted to prevent air from entering the feeding system.

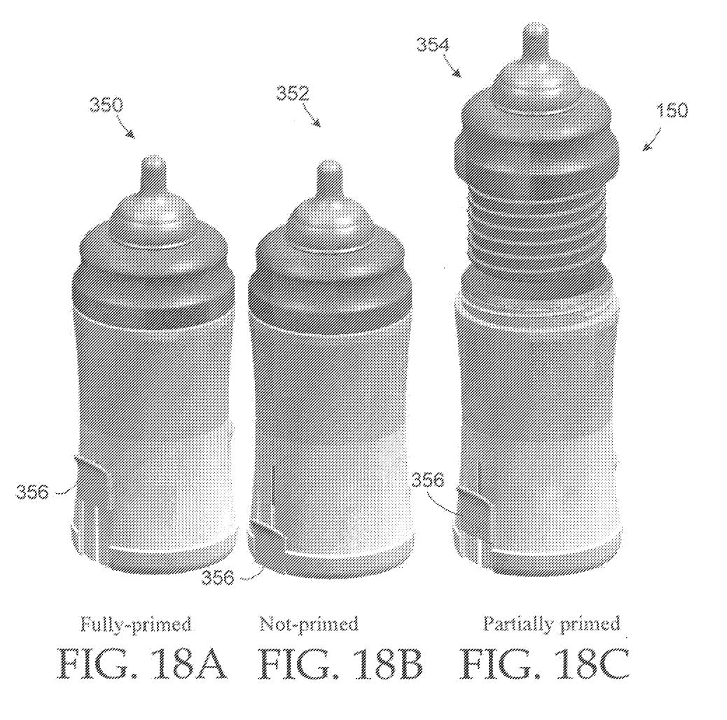

FIG. 18A, FIG. 18B, and FIG. 18C illustrate one embodiment of a priming technique for the feeding system. For example, FIG. 18A illustrates a fully-primed infant feeding system 350. FIG. 18B illustrates an un-primed infant feeding system 352. FIG. 18C illustrates a partially-primed infant feeding system 354. In this embodiment, a movable tab 356 is used to collapse the reservoir liner and facilitate the priming. By priming, we mean evacuating air from the infant feeding system 350. The movable tabs 356 are connected to a priming mechanism (not shown) that is located, inside the infant feeding system 354. For example, the priming mechanism can embody a component that is positioned under a collapsible reservoir liner. The component can be disk-shaped or any other suitable shape. The reservoir liner collapses as the tab 356 (and the component) are moved upward toward the nipple. The collapsing reservoir forces air inside the reservoir liner to escape through the nipple orifice. The priming mechanism can include other components, such as levers or cams that increase the mechanical advantage of the tab 356.

A priming technique according to one embodiment substantially eliminates the air space on top of the liner reservoir 310 (FIG. 16) prior to forming the seals in the system 300 of FIG. 16. Accordingly, the volume of air left to be evacuated during priming is reduced. The priming technique also allows the liquid feed to be heated as the heat exchanger section 302 (FIG. 16) is being inserted into the liner reservoir 310.

As the heat exchanger section 302 is inserted some of the liquid feed in the reservoir 310 will begin to flow up through the flow path and absorb the heat from the TESU 304. This exposes the liquid to the heat exchanger for an extended period of time, thereby reducing the risk of the initial liquid feed being delivered to the infant at an inappropriate temperature.

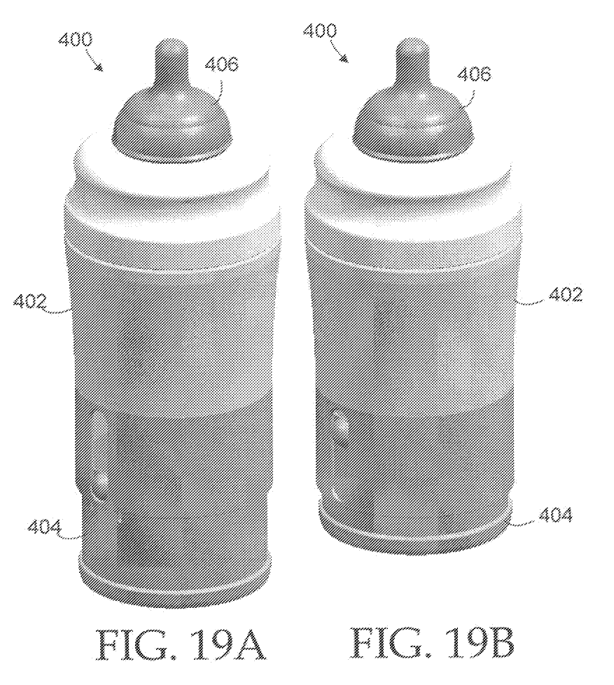

FIG. 19A and FIG. 19B illustrate another embodiment of a priming technique for an infant feeding system 400. In one embodiment, a priming technique according to one embodiment involves mating two telescoping coaxial shells 402, 404 that form a frictional interfit. To facilitate the priming, the infant feeding system 400 can be placed on a flat surface and the top shell 402 can be pushed down. This reduces the vertical distance available to the liner and causes it to collapse, thereby evacuating the air through the small orifice in the nipple 406. The two coaxial shells 402, 404 will remain in the same position due to a fractional interfit. This arrangement also has the additional advantage of reducing the overall size of the infant feeding system 400.

In one embodiment, one of the coaxial shells 402, 404 includes a reservoir liner and the other coaxial shell 402, 404 is attached to a dispenser or nipple. The coaxial shells 402, 404 can be concentric with respect to each other. Displacing the first coaxial shell 402 with respect to the second coaxial shell 404 collapses the reservoir liner thereby evacuating air through the dispenser and priming the system 400.

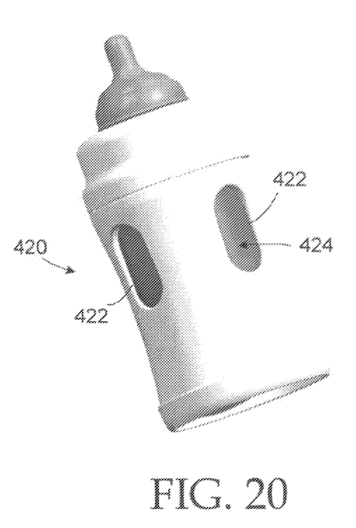

FIG. 20 illustrates one embodiment of a shell 420 of an infant feeding system. The shell 420 includes a plurality of windows 422. The windows 422 are configured such that a surface of an internal liner 424 that is in contact with the TESU is accessible to the fingers of a caregiver. For example, when a hand of a caregiver is placed over the windows 422, the hand will be in thermal contact with the outer surface of the liner 424 containing the liquid feed. Accordingly, the windows 422 can help to provide a temperature feedback to the caregiver. Therefore, the caregiver can perceive the temperature of the liquid throughout the feed. This provides a level of comfort to the caregiver that the liquid feed is not overheated. The windows 422 can also improve the grip of the caregiver.

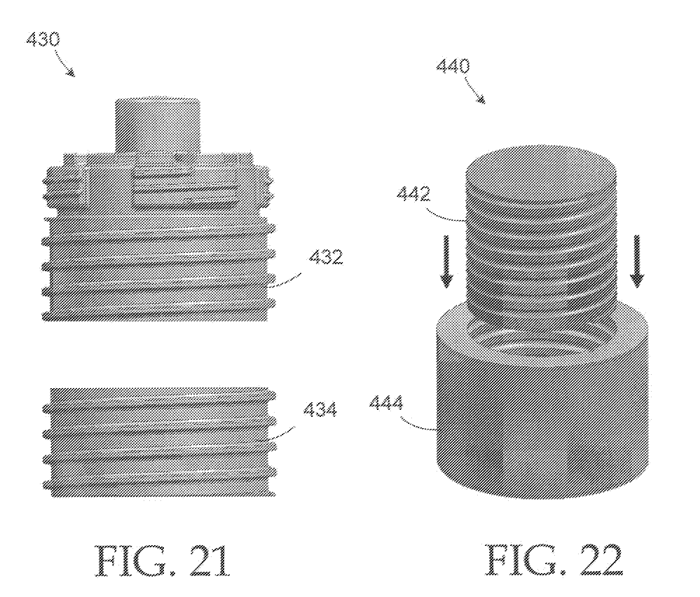

FIG. 21 illustrates one embodiment of a thermal energy storage unit (TESU) 430. The TESU 430 can be fabricated from modular blocks 432, 434. These blocks 432, 434 can be releasably coupled to each other to create different heating capacities. In one embodiment, this modular construction can provide different heating options. For example, a very young infant who can only drink a small amount of liquid can be fed from a smaller bottle that uses a small primary TESU consisting of one block 432. As the infant grows and demands more liquid feed during each feeding session, the TESU's overall heating capacity can be increased by attaching a secondary TESU 434 to the primary TESU 432. For example, each of the TESUs 432, 434 can be arranged to create bottles that can have 4-ounce or 8-ounce heating capacities. The primary 432 and secondary TESUs 434 can be engaged in several different arrangements. For example, FIG. 21 illustrates a back-to-back arrangement.

FIG. 22 illustrates one embodiment of a thermal energy storage unit (TESU) 440. In this embodiment, a primary TESU 442 is dropped into the secondary TESU 444 coaxially. The conduits in the primary 442 and the secondary TESUs 444 coincide to form a closed flow-path or fluid circuit.

Another feature of the feeding system includes a sanitizing technique that can clean and sanitize the reusable components of the feeding system. Preferably, a heat source (not shown) in a base station, (not shown) can be used for sanitizing the drop-in assembly. This can be achieved using dry heat or wet heat. Alternatively, sanitization can be achieved using another sanitization source such as UV, which can be incorporated, into the charging station. Additionally, the charging station can be made portable by offering a battery hook-up option. The charging station can also include rechargeable batteries as a means to keep the drop-in assembly at the required temperature.

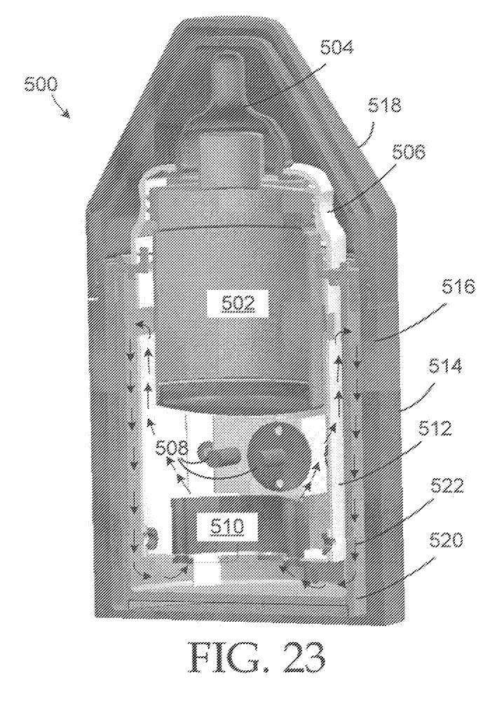

FIG. 23 illustrates a cross-sectional view of a charging device 500 for use with an infant feeding system. The charging device 500 is capable of thermally charging one or more thermal energy storage units (TESUs) 502. The thermal energy storage unit (TESU) 502 can be particularly used for the infant feeding system. However, the charging device 500 is also capable of sanitizing the reusable components of a feeding system that comes into contact with liquid feed. Typically, the reusable components include the nipple 504, retaining ring 506 and thermal energy storage unit (TESU) 502.

The charging device 500 includes a heat source 508, a fan 510, a frame 512, a housing 514, a shell 516, and a cap 518. The frame 512 is a cylindrical receptacle disposed coaxially inside the inner wall 520 and affixed to the shell 516. The frame 512 houses and secures the heat source 508 and the fan 510. In one embodiment, the frame 512 is fabricated from heat-resistant material such as sheet metal. In one embodiment, cartridge heaters are used as the heat source 508. However, a number of different heat sources can be employed which will be described in the following sections.

The frame 512 is configured to retain the drop-in assembly when it is inserted into the charging station 500. The drop-in assembly includes the TESU 502, the retaining ring 506 and the nipple 504 which are reusable components that contact the liquid feed.

The inner wail 520 can be a separate component or it can be integrated with the shell 516. The frame 512 and the inner wall 520 create a passageway for the connective currents 522 as shown by the arrows in FIG. 23. The fan 510 facilitates the heat transfer by inducing such convective currents 522 inside the charging station 500. The fan 510 draws air from the bottom, of the housing 514 and exhausts it upward. The blown air is heated as it passes around the heating element 508. The convective currents engulf the TESU 502 and heat is transferred from the surface of the TESU 502 to its core which incorporates a phase change material (PCM). The convective currents 522 exit the interior of the frame 512 through a plurality of openings in the frame 512. These convective currents 522 then flow to the bottom of the frame 512 by the fan 510 where the convection cycle begins again.

A portion of the bulk motion of the air also results from buoyancy induced flow. Since the drop-in assembly is located above the heating element 508, natural convection enhances the bulk motion of the air. In other embodiments, the fan 510 is removed and natural convection can be employed as the primary means of heat transfer.

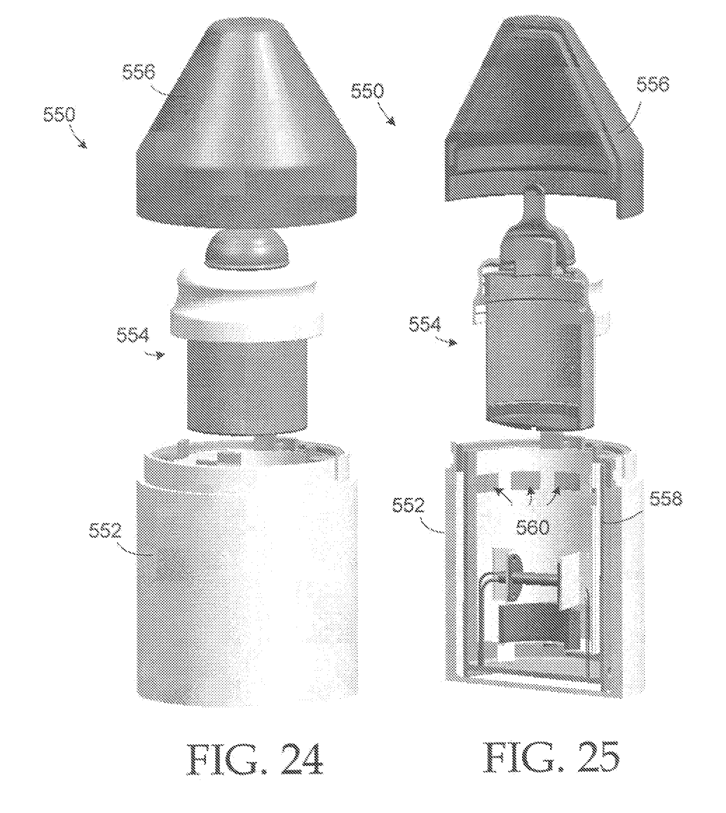

FIG. 24 illustrates an external view of one embodiment of a charging device 550. The charging device 550 includes an insulated shell 552. The insulated shell 552 can be in the shape of a cylinder or any other suitable shape. Also shown are a drop-in module 554 and a cap 556.

FIG. 25 illustrates a cross-sectional view of the charging device 550 of FIG. 24. In one embodiment, the insulated shell 552 incorporates a dual-wall construction including an air-gap 558. The air-gap 558 can improve thermal insulation.

In one embodiment, the cap 556 also provides thermal insulation to the system and can also employ a dual-wall construction. The thermal insulation maintains an exterior temperature that is below a specified level to ensure safe handling of the charging station 550. The thermal insolation also minimizes heat transfer to the surroundings which improves charging times as well as energy efficiency. The cap 556 and the insulated shell 552 can he made of thermally insulating materials as well. In one embodiment, the shell 552 can include one or more openings 560. The openings 560 can facilitate the flow of convection currents.

A fully discharged TESU refers to a unit in which the associated PCM is in solid form. A charged TESU refers to a unit in which all of the PCM is in the liquid state. A drop-in assembly 554 with a discharged TESU is placed in the charging station 550, for example, after a typical feed. Once the power is turned on, the temperature of the heating element, rises based on joule heating.

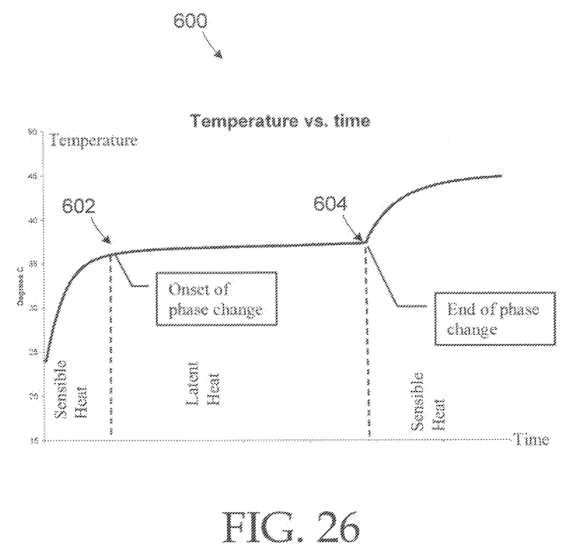

FIG. 26 is a graph 600 of temperature versus time during a charging cycle for a thermal energy storage unit. The thermal energy storage unit is placed in a charging station 550 (FIG. 25) to be re-activated. In some embodiments, the charging station 550 also includes temperature sensors with associated control circuitry. The temperature sensors can be a number of different types including thermocouples, Resistance Temperature Detectors (RTDs) and non-contact temperature measurement sensors such as infrared (IR) sensors. Based on closed-loop feedback, any desired heating profile can be used for heating.

In one embodiment, the charging station 550 is also capable of detecting the point at which the TESU is fully charged. For example, by sensing the external temperature of the TESU, the system can infer whether the system is fully charged.

The graph 600 of FIG. 4 illustrates a typical heating curve where temperature is measured on the surface of a TESU during charging. As the TESU is heated, the temperature rises until, the PCM begins to change state 602. For example, at this point, the PCM begins to melt. Any additional heat transferred to the TESU is transferred into the latent heat of fusion resulting in a nearly isothermal response. Once the entire solid PCM has changed state (e.g., melted), any additional beat causes further increase in the temperature of the TESU.

In one embodiment, the end of charging 604 can be determined by monitoring the rate of temperature change on the surface of the TESU. In addition, the TESU and/or the charging station can have an indicator that shows charging status.

A variety of different, heating elements can be employed. These include resistive heating elements such as etched foil flexible heaters, cartridge heaters, wound wire heaters, as well as thermoelectric heaters. The heating element can be powered from either a wall outlet or a battery unit, for example.

Alternatively, induction heating can also be employed. Heating can be accomplished by using a high frequency alternating-current (AC) power supply. The induction coil can be disposed coaxially along the inner wail. Alternatively, a flat-style induction coil can be located on the bottom of the charging station. The associated ferromagnetic induction heating target can be incorporated into the TESU. When the TESU is placed inside the charging station, the induction target is placed in close proximity to the induction coil. The targets can include a sleeve inside the housing or a dish located on the bottom of the TESU. In one embodiment, the TESU housing is used as the target. The eddy currents created in the target by the alternating magnetic field create resistive heating which is transferred to the surroundings. One advantage of induction heating is that it can provide a rapid thermal response and shorter charging times based on localized heating and proximity to PCM.

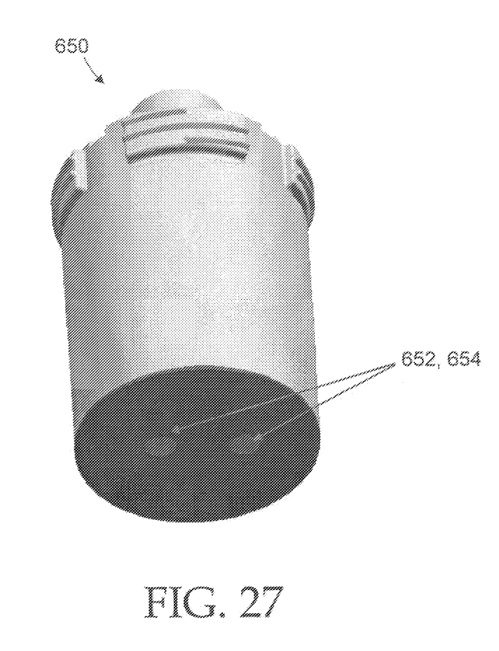

FIG. 27 illustrates a thermal energy storage unit (TESU) 650 having an internal resistive heating element with terminals 652, 654 that can be coupled to an external power source. In one embodiment, the internal resistive heating element includes a resistive filament. The internal heating element can be connected to a power source using the terminals 652, 654 in the TESU 650. This integral heating arrangement provides faster and more efficient heating.

Sanitization can be achieved using dry heat, wet heat, or ultraviolet (UV) radiation. Dry-heat sanitation refers to the germicidal effect of reaching high surface temperatures. Likewise, wet heat refers to using steam to enhance the sanitization process. Using heat sanitization can be advantageous because the heat can be used to charge the base station, as well as kill any bacteria. Skilled artisans will appreciate that time and temperature are a function of the level of efficacy as well as the heating method.

In one embodiment, if the temperature of the contents of the charging station is higher than the allowable contact temperature, a safety locking mechanism or interlock is used to prevent the user from opening the charging station and handling its contents. The interlock can be constructed using several techniques such as a bimetal strip actuated locking mechanism. In an embodiment in which UV sanitization is used, a similar interlock mechanism can be employed to prevent the user from opening the charging station while the UV light is active.

In addition to regulating the temperature using closed-loop feedback, the system can also incorporate various self-regulating heating elements that reduce the heat output when a desired temperature is reached. This ensures that the TESU is never heated to a temperature that would cause the liquid feed to be too hot for the infant. Two such examples of such self-regulating heating elements are Positive Temperature Coefficient (PTC) heaters and self-regulating induction heaters.

A Positive Temperature Coefficient heater increases its internal resistance as its temperature increases. This limits the current flow in the heater which prevents additional heating. Similarly, if induction heating is employed, the Curie temperature of a ferromagnetic target can be used to regulate the temperature. For example, as the temperature of the target approaches the Curie temperature of the ferromagnetic material, the decline in magnetic permeability of the target material limits additional heat output. Thus, the target material can be selected with the desired Curie regulation temperature.

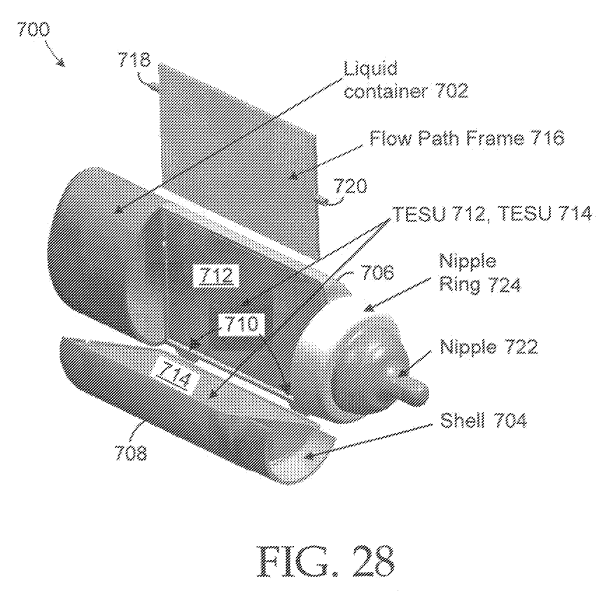

FIG. 28 illustrates a cross-sectional view of an embodiment of an infant feeding system 700. The infant feeding system 700 includes a liquid container 702 that contains the unhealed liquid feed. The liquid container 702 can be coupled to a shell 704. For example, the liquid container 702 can include threads that mate with threads located on the shell 704. The shell 704 can be formed from two sections 706, 708, in one embodiment, the two sections 706,708 are coupled together with hinges 710 and form a clamshell. The two sections 706, 708 can also be mechanically coupled together using other techniques.

Each of the two sections 706, 708 includes a thermal energy storage unit (TESU) 712, 714, respectively. A frame 716 outlining a fluid circuit is sandwiched between the two TESUs 712, 714. The frame 716 includes an input port 718 and an output port 720. In one embodiment, the frame 716 is disposable and is replaced before the next feeding. In one embodiment, the frame 716 is reusable and can be washed by hand or by using an automatic dishwasher.

The infant feeding system 700 also includes a nipple 722. A ring 724 is used to secure the nipple 722 to the shell 704. The output port 720 on the frame 716 directs the liquid feed into the nipple 722.

in operation, the frame 716 is dropped in between sections 706 and 708. The two sections 706, 708 of the shell 704 are joined together to form a cylindrical shell. The nipple 722 is secured to the top of the cylindrical shell using the nipple ring 724. The liquid container 702 containing the liquid feed is secured to the bottom of the cylindrical shell. As the cylindrical shell is tipped, the liquid feed flows through the fluid circuit in the frame 716 and is heated on-demand as it contacts the TESUs 712, 714. The liquid feed reaches the desired temperature when it arrives at the output port 720 in the frame 716. The liquid feed then flows into the nipple 722 having the desired temperature.

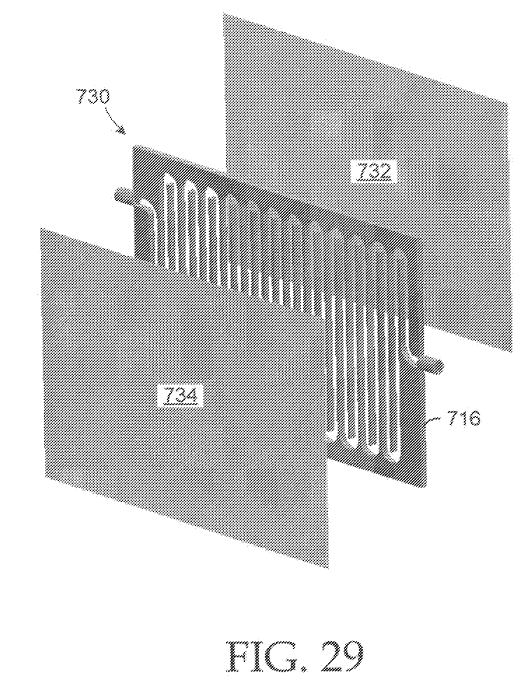

FIG. 29 illustrates an example of a fluid circuit 730 described by the frame 716 shown in FIG. 28. The fluid circuit 730 in this example is serpentine in nature. Fluid circuits having other shapes are also possible. The fluid circuit 730 is sandwiched between two sections of foil 732, 734. The two sections of foil 732, 734 are used to seal the fluid circuit 730 such that liquid remains in the fluid circuit 730. The sections of foil 732, 734 can be fabricated from material having a high thermal conductivity. Materials having high thermal, conductivity can assist in transferring heat from the TESUs 712, 714 (FIG. 28) to the liquid feed in the fluid circuit 730. In some embodiments, materials other than foils can be used.

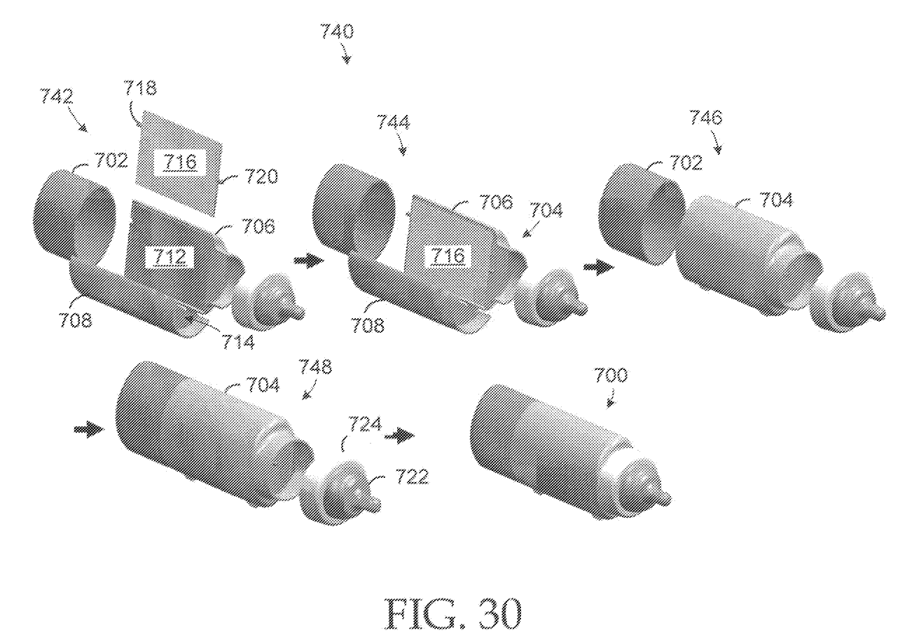

FIG. 30 illustrates a method of assembly 740 of the infant feeding system 700 of FIG. 28. In a first step 742, the frame 716 is positioned between the two sections 706, 708 of the shell 704. The positions of the input port 718 and the output port 720 can be used to determine the proper orientation of the frame 716. In one embodiment, the input port 718 includes a one-way valve that prevents liquid in the fluid circuit from flowing back into the liquid container 702. In a second step 744, the two sections 706, 708 of the shell 704 are brought together. The two sections 706, 708 are clamped together such that the frame 716 is tightly secured in the shell 704. In a third step 746, the liquid container 702 containing the liquid feed is attached to the shell 704. In a fourth step 748, the nipple 722 is secured to the shell 704 with the nipple ring 724.

The two sections 706, 708 of the shell 704 can be mechanically secured together using various damping mechanisms. For example, the frame 716 can be tightly sandwiched between the TESUs 712, 714 by using fastening techniques having high mechanical leverage. The mechanical leverage can be achieved using various mechanisms such as linkages or cam-based mechanisms. In one embodiment, the nipple ring 724 is threaded onto the shell 704 and provides the desired mechanical leverage. The thermal contact resistance between the TESUs 712, 714 and the frame 716 is reduced as the pressure of the TESUs 712, 714 sandwiching the frame 716 increases.

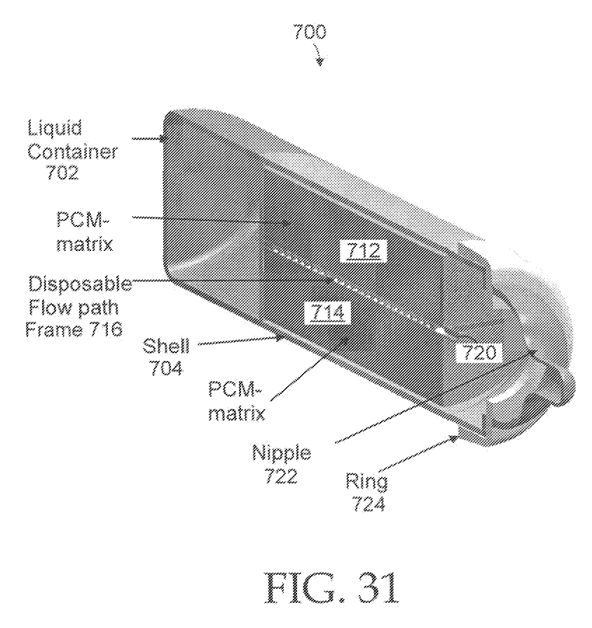

FIG. 31 is a cut-away view of the assembled infant feeding system 700 of FIG. 28. The infant feeding system 700 includes the liquid container 702 that contains the initial liquid feed. The liquid container 702 can include volume markings (not shown), such as embossed lines that indicate 2 oz, 4 oz, 6 oz, and/or 8 oz levels. The liquid container 702 is connected to the shell 704 through a mechanical coupling. For example, the mechanical coupling can be a threaded connection or a friction fit. The shell 704 includes the TESUs 712, 714. The frame 716 is sandwiched between the TESUs 712, 714. The frame 716 defines the fluid circuit through the TESUs 712, 714. The liquid feed flows through the fluid circuit and exits through the output port 720 into the nipple 722. The nipple 722 is secured to the shell 704 with the nipple ring 724.

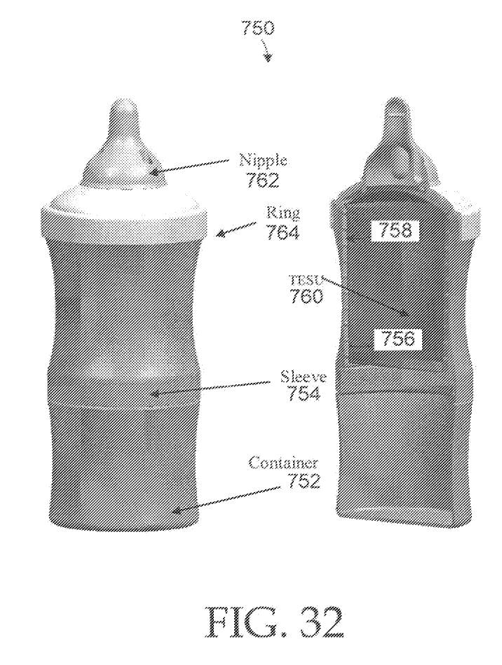

FIG. 32 illustrates another embodiment of an infant feeding system 750. A liquid container 752 is used to store liquid feed prior to feeding. The liquid container 752 is attached to a sleeve 754 of the infant feeding system 750 prior to the feed. In one embodiment, the interior wall 756 of the sleeve 754 includes a fluid circuit 758. The fluid circuit 758 can be molded into the sleeve 754 or can be cut into the sleeve 754. In one embodiment, the sleeve 754 is fabricated from a washable plastic material. In practice, the sleeve 754 can be fabricated from any suitable material.

The infant feeding system 750 also includes a TESU 760. The TESU 760 is designed to lit inside the sleeve 754. Energy from the TESU 760 is absorbed by the liquid feed as it flows through the fluid circuit 758. A nipple 762 is secured to the sleeve 754 with a nipple ring 764.

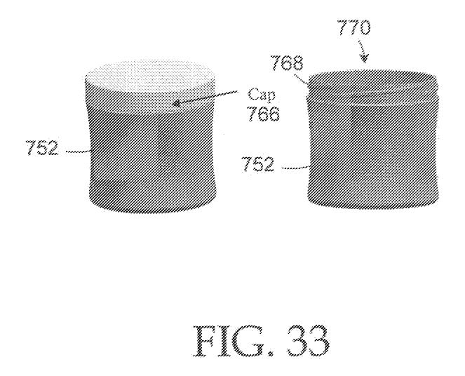

FIG. 33 illustrates the liquid container 752 of FIG. 32. The liquid container 752 can be sealed by using a cap 766. The cap 766 can be a threaded cap having threads that mate with threads 768 on the liquid container 752, in one embodiment, the cap 766 can snap over the mouth 770 of the liquid container 752. Once capped, the liquid feed can be stored in the liquid container 752 and refrigerated for later use. Prior to the feed, the cap 766 is removed from the container 752. Subsequently, the threads 768 are used to mate the container 752 to the bottom of sleeve 754 to form the infant feeding system 750.

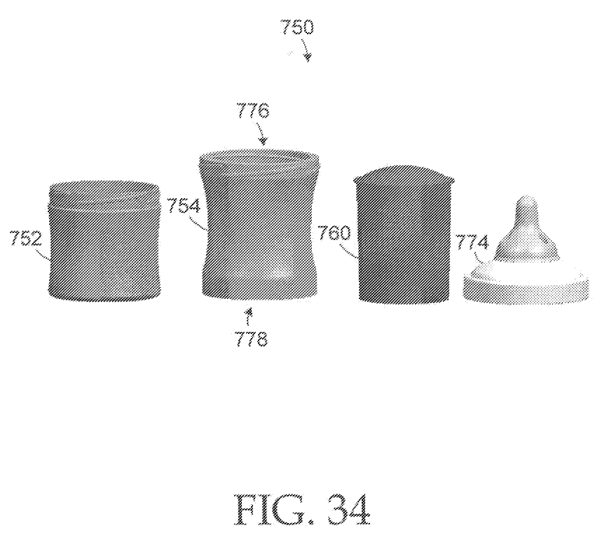

FIG. 34 illustrates the components of the infant feeding system 750 of FIG. 32. For example, the components include the liquid container 752, the sleeve 754, the TESU 760, and a nipple/ring assembly 774. The nipple/ring assembly 774 can include threads that mate with threads on the sleeve 754. In one embodiment, the TESU 760 is loaded into the sleeve 754 through the top 776 of the sleeve 754. Alternatively, the TESU 760 can he loaded into the sleeve 754 through the bottom 778 of the sleeve 754.

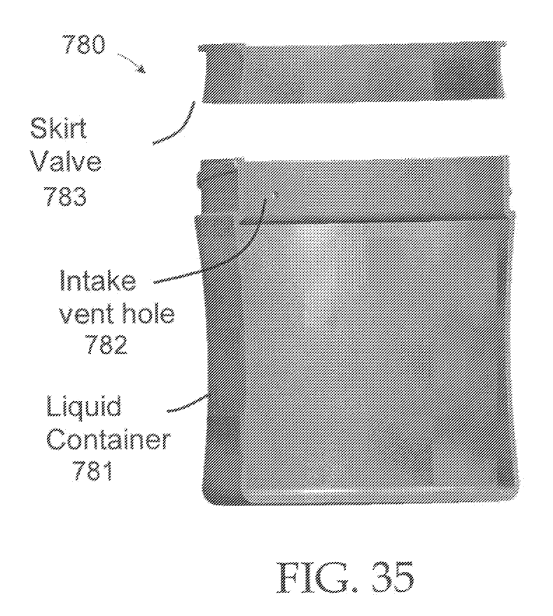

FIG. 35 illustrates a priming mechanism 780 which can be used with the infant feeding system 750 of FIG. 32. The infant feeding system 750 of FIG. 32 includes a rigid container 752 as opposed to a collapsible liner. Thus, an alternate method of priming is necessary that does not exploit the collapsible nature of a collapsible liner. For example, the liquid container 752 is rigid and capable of storing liquid feed. The liquid container 752 also provides structural support to the rest of the infant feeding system. Accordingly, the rigid container 752 does not lend itself to upright priming as previously illustrated with a collapsible liner.

In the embodiment shown, the priming mechanism 780 includes a liquid container 781 including a vent hole 782 and a skirt valve 783. The skirt valve 783 is positioned coaxially relative to the liquid container 781. The skirt valve 783 can embody a separate component. Alternatively, the skirt valve 783 can be integrated with the liquid container 781. For example, the skirt valve 783 can be co-molded with the liquid container 781. In some embodiments, low durometer materials such as silicone can be used in the construction of the skirt valve 783.

One or more intake vent holes 782 can be located at various positions in the liquid container 781. The skirt valve 783 forms a circular seal that is effectively positioned below the intake vent holes 782. The intake vent holes 782 can alternatively be positioned in the skirt valve 783. Various alternative valving arrangements can be used to achieve similar results.

The skirt valve 783 acts as a non-return valve. It prevents the liquid from leaking out of the infant feeding system 750 by radially sealing the seam between the liquid container 781 and the rest of the infant feeding system. However, the skirt valve 783 is designed to allow air that is external to the infant feeding system to enter the liquid container 781 based on a specified pressure difference. This specified pressure difference between the atmospheric pressure and the pressure inside the liquid container 781 is referred to as the crack pressure. In one embodiment, the skirt valve 783 is designed to have a low crack pressure.

In operation, when the infant feeding system is inverted, liquid in the liquid container 781 flows down the fluid circuit towards the nipple. This creates a pressure depression in the liquid container 781 and a pressure increase inside the nipple. The pressure depression in the liquid container 781 causes the skirt valve 783 to activate and air to flow into the intake vent holes 782. The pressure rise actuates an exhaust vent (not shown) that is positioned proximate to the nipple. When the bottle is inverted for feeding, the exhaust vent is higher than the nipple so that air in the nipple is displaced gravitationally by fluid, and evacuates through the exhaust vent, not the nipple.

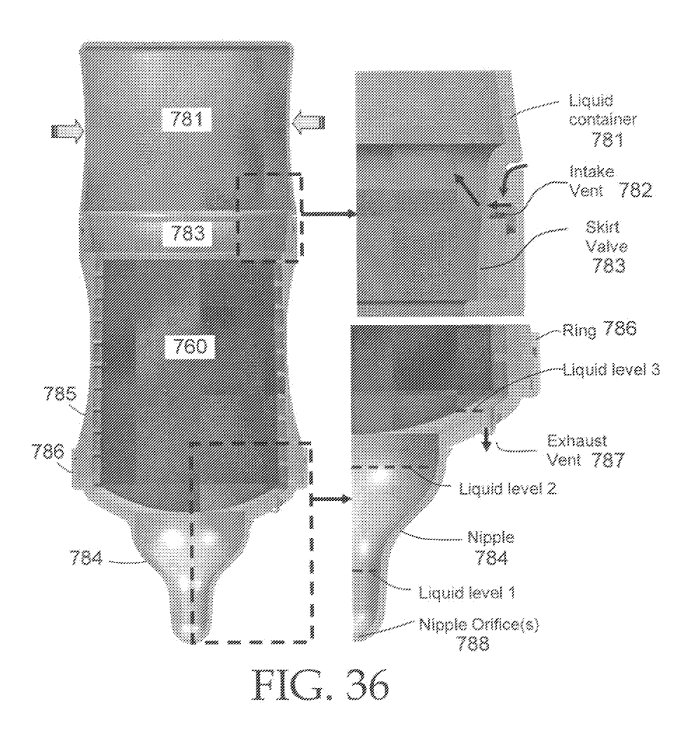

FIG. 36 illustrates a detailed diagram of the priming mechanism 780 of FIG. 35. The infant feeding system includes the liquid container 781, the intake vent hole 782, and skirt valve 783. The infant feeding system also includes the TESU 760. A nipple 784 is coupled to a shell 785 with a ring 786. Either the nipple 784, the shell 785, or the ring 786 can include an exhaust vent 787. The nipple 784 also includes one or more orifices 788 for feeding.

In one embodiment, a user can squeeze the sides of the liquid container 781 to facilitate priming and induce a pumping action. The liquid container 781 is generally fabricated from a compliant plastic material and its volume is reduced in response to the squeezing.

The nipple orifice(s) 788 are closed during the priming process. The nipple orifice(s) 788 are effectively valves that are actuated by radial compression due to the suckling of the infant. In the absence of infant suckling the nipple orifice(s) behave as closed valves (i.e., valves with crack pressure that are substantially higher than the maximum pressure present in the nipple). This type of valving can be achieved by positioning one or more slits in the tip of the nipple 784.

As the air in the nipple 784 is expelled through the exhaust vent 787, liquid begins to accumulate in the nipple reservoir as shown by the different liquid levels in FIG. 36. When the liquid level rises to level 3, the nipple reservoir is substantially filled with liquid. At liquid level 3, the liquid starts to exit from the exhaust vent 787. The priming process is concluded once the liquid begins to exit through the exhaust vent 787. Additionally, the small amount of liquid that exits the exhaust vent 787 can serve as a confirmation to the user that the liquid temperature is in the desired range. Many caregivers typically test the first few drops of liquid to monitor the temperature of the liquid.

If the bottle is positioned upright during the feeding process, a substantial amount of the liquid is preserved in the nipple area due to surface tension. This obviates the need for repeating the priming process during a feeding session.

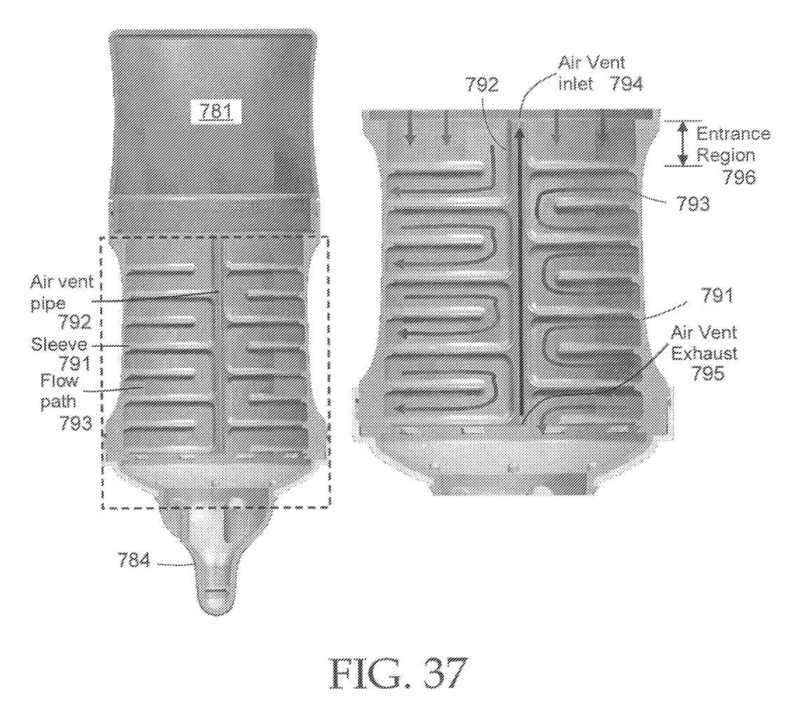

FIG. 37 illustrates another priming mechanism 790 for the infant feeding system 750 of FIG. 32. The TESU is removed in FIG. 32 for clarity. In this embodiment, a shell 791 includes an air vent 792 as well as a fluid circuit 793. A first end of the air vent 792 includes an air vent inlet 794 and a second end includes an air vent exhaust 795. The fluid circuit 793 fluidly couples the liquid container 781 to the nipple 784. In other embodiments, multiple fluid circuits can also be used.

When the infant feeding system 750 is inverted, liquid immediately fills up an entrance region 796 of the fluid circuit 793 thereby creating a pressure differential between the two ends of the air vent 792. The pressure differential arises as a result of a transient event in which the fluid circuit 793 offers less resistance to the flow of the liquid than pressure in the air vent 792.

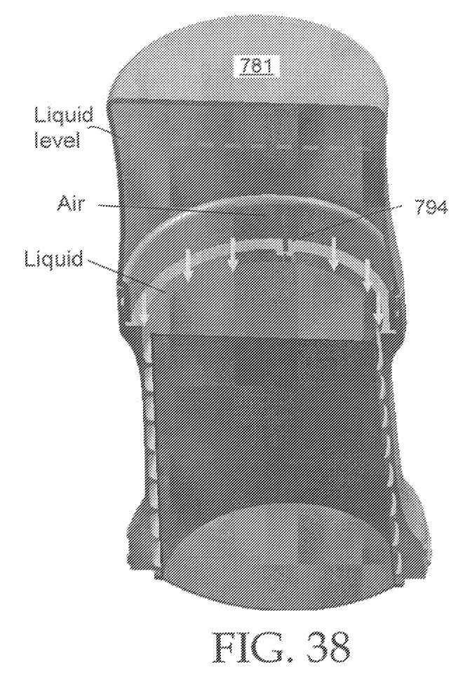

FIG. 38 is a detail of the priming mechanism of FIG. 37. Once the pressure at the air vent exhaust 795 (FIG. 37) exceeds the pressure at the air vent inlet 794, air is forced to move up and enter into the liquid container 781 as shown in FIG. 38. Air exiting at the air vent exhaust 795 bubbles towards the liquid container 781. Gradually, all the air in the flow path 793 and the nipple 784 is forced up through the air vent 792.

Unlike the previous method of priming illustrated in FIG. 35 and FIG. 36, the priming mechanism 790 illustrated in FIG. 37 does not exchange air with the ambient atmosphere that is external to the infant feeding system. The air trapped in the nipple 784 is effectively transferred to the liquid container 781.

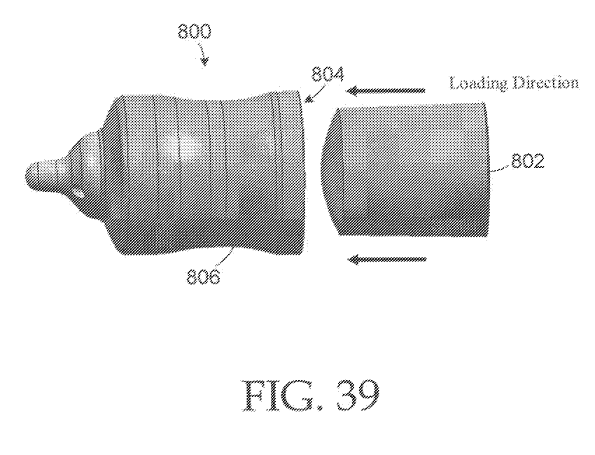

FIG. 39 illustrates one embodiment of a nipple/sleeve assembly 800. The nipple/sleeve assembly 800 can be formed as a single unit or can be disassembled into multiple components. The nipple/sleeve assembly 800 can be sanitized, in a dishwasher or can be hand-washed, for example, hi this embodiment, a TESU 802 is inserted through the bottom 804 of the nipple/sleeve assembly 800. The TESU 802 can be secured to the nipple/sleeve assembly 800 through a friction fit. In one embodiment, the shape of the TESU 802 and the sleeve section 806 can he tapered to facilitate the friction fit.

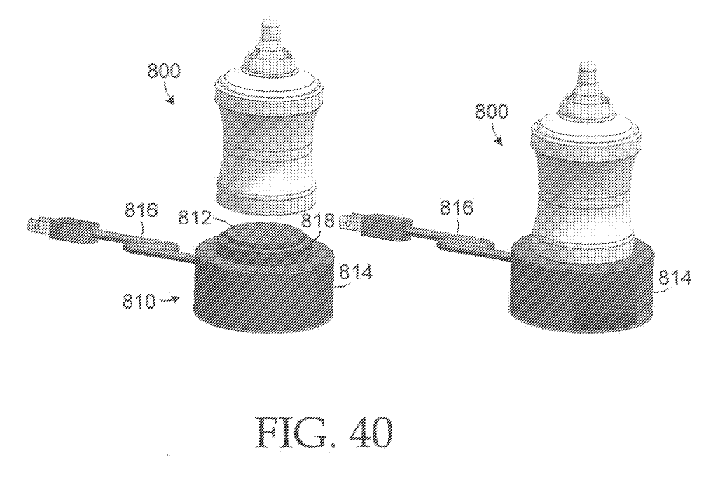

FIG. 40 illustrates one embodiment of a charging station 810 for use with the nipple/sleeve assembly 800 of FIG. 39. The charging station 810 includes a heating pad 812, a base 814 and a power cord 816. The base 814 contains electronics for controlling the heating pad 812. The top of the base 814 includes threads 818 that mate with threads in the nipple/sleeve assembly 800. The threads 818 on the base 814 can be substantially the same as the threads on the liquid container 752 (FIG. 33).

In this embodiment, the nipple/sleeve assembly 800 is used as an insulating housing for the TESU 802 (FIG. 39). For example, the components of the nipple/sleeve assembly 800 can be fabricated from a low thermal conductivity material. The low thermal conductivity material coupled with an internal air gap creates an insulating envelope around the TESU 802. This helps in reducing heat loss to the ambient throughout the operation of the charging station.

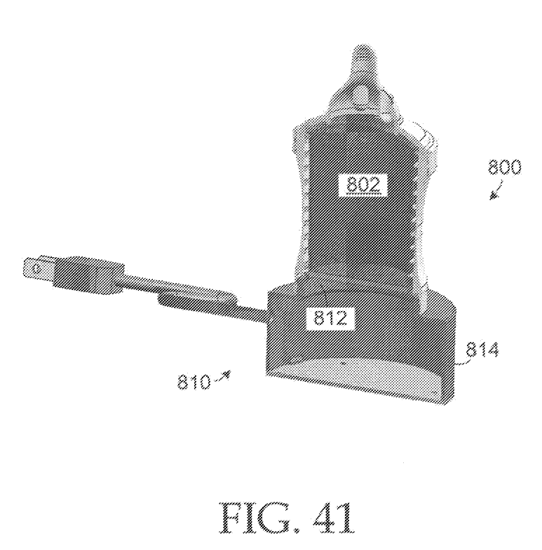

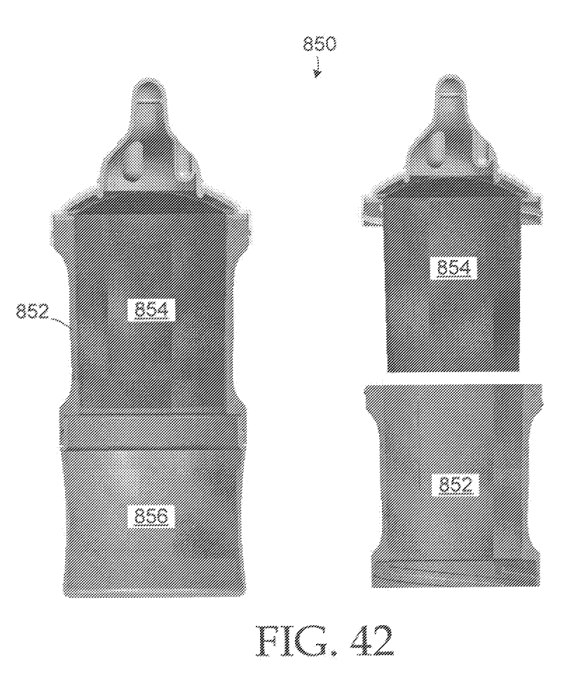

FIG. 41 is a cut-away view of the charging station 810 of FIG. 40. The base 814 of the charging station 810 includes electronics (not shown) that control parameters of the heating pad 812. For example, the electronics can include timer circuitry that controls the amount of time the heating pad 812 is active. The electronics can also include circuitry that controls the amount of energy delivered to the heating pad 812. This can prevent undesirable overheating of the heating pad 812. For example, when the nipple/sleeve assembly 800 is removed from the charging station 810, the heating pad 812 is uncovered. The electronics inside the base 814 prevents the heating pad 812 from becoming too hot for a user to touch.

When the nipple/sleeve assembly 800 is placed onto the charging station 810, the bottom face of the TESU 802 contacts the heating pad 812. Thus, the primary heat exchange mechanism during the charging cycle is conduction.

FIG. 42 illustrates another embodiment of an infant feeding system 850. The infant feeding system 850 includes a sleeve 852 having an annular flow path or fluid circuit. The annular flow path is formed when a TESU 854 is positioned coaxially inside the sleeve 852. The annular flow path can be advantageous in the case of a non-collapsible liquid container 856 because priming is only required once during the course of the feed. This initial priming speed is calibrated by appropriately sizing the annulus to maintain surface tension of the liquid feed. When the infant feeding system 850 is oriented in an upright position, the force from the surface tension offsets the mass of the liquid feed in the flow path. Thus, the force from the surface tension of the liquid feed acts like a check valve that substantially prevents backflow into the liquid container 856.

The foregoing description is intended to be merely illustrative of the present invention and should not be construed as limiting the appended claims to any particular embodiment or group of embodiments. Thus, while the present invention has been described with reference to exemplary embodiments, it should also be appreciated that numerous modifications and alternative embodiments may be devised by those having ordinary skill in the art without departing from, the broader and intended spirit and scope of the present invention as set forth in the claims that follow. In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
e) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

What is claimed is:

1. An apparatus for heating a liquid comprising:
a housing;
a liquid reservoir contained within the housing;
a fluid circuit for conveying liquid from the reservoir to a dispenser; and
a thermal energy storage unit contained within the housing and disposed to be in thermal contact with the fluid circuit, the thermal energy storage unit constructed and arranged to heat liquid as it passes thru the fluid circuit.

2. The apparatus of claim 1 wherein fluid passes thru the fluid circuit on demand.

3. The apparatus of claim 1 wherein the thermal energy storage unit comprises a phase change material.

4. The apparatus of claim 1 wherein the thermal energy storage unit comprises a combination of a phase change material and a high thermal conductivity material.

5. The apparatus of claim 4 wherein the phase change material is disposed within a matrix of a high thermal conductivity material.

6. The apparatus of claim 1 wherein the fluid circuit is disposed on the outer surface of the thermal energy storage unit.

7. The apparatus of claim 1 wherein the fluid circuit comprises a plurality of separate fluid circuits disposed on the outer surface of the thermal energy storage unit.

8. The apparatus of claim 6 wherein the fluid circuit comprises a plurality of separate fluid circuits disposed on the outer surface of the thermal energy storage unit.

9. The apparatus of claim 1 wherein the fluid circuit comprises a continuous helical groove disposed in part along the thermal energy storage unit.

10. The apparatus of claim 1 wherein the fluid circuit is located at least partially within the thermal energy storage unit.

11. The apparatus of claim 1 wherein the thermal energy storage unit is decoupled from the apparatus for charging.

12. The apparatus of claim 3 wherein the phase change material has a phase transition temperature within five degrees Celsius of human body temperature.

13. The apparatus of claim 1 wherein the liquid reservoir comprises a removable liner.

14. The apparatus of claim 13 wherein the removable liner is collapsible.

15. The apparatus of claim 1 wherein the housing is divided into two sections, the first section containing the thermal energy storage unit for heating fluid to a desired operating temperature, and the second section containing the fluid reservoir for holding fluid prior to being heated by the thermal energy storage unit.

16. The apparatus of claim 15 wherein the second section is thermally isolated from the first section.

17. A method of heating a fluid within a feeding system comprising the acts of:
containing fluid within a fluid reservoir;
drawing the fluid through a fluid circuit; wherein, fluid within the fluid circuit is in thermal contact with a thermal energy storage unit; and
conducting heat from the thermal energy storage unit to the fluid to heat the fluid.

18. The method of claim 17 wherein the fluid is heated substantially on demand.

19. The method of claim 17 wherein the act of conducting heat comprises raising the temperature of the fluid to a desired operating temperature

20. The method of claim 19 wherein the desired operating temperature is within approximately five degrees Celsius of normal human body temperature.

21. The method of claim 17 wherein the fluid circuit is disposed on the outer surface of the thermal energy storage unit.

22. The method of claim 17 further comprising charging the thermal energy storage unit to its operating temperature prior to feeding.

23. The method of claim 17 wherein the fluid reservoir further comprises a collapsible liner.

24. The method of claim 17 wherein the thermal energy storage unit further comprises a phase change material.

25. The method of claim 24 wherein the thermal energy storage unit further comprises a combination of a phase change material and a high thermal conductivity material.

26. An apparatus for heating a liquid comprising:
a housing;
a liquid reservoir contained within the housing;
a first fluid circuit conveying liquid from the reservoir to a dispenser;
a heat source in thermal contact with the first fluid circuit; and
a priming system whereby gas is evacuated from the first fluid circuit through a second fluid circuit when the apparatus is in an inverted position.

27. The apparatus of claim 26 further comprising a vacuum management system to reduce the creation of voids when liquid is drawn down from the reservoir.

28. The apparatus of claim 26 wherein the heat source comprises a thermal energy storage unit.

29. The apparatus of claim 27 wherein the vacuum management system further comprises a third fluid circuit and a flow control mechanism, where the flow control mechanism allows air to enter the reservoir through the third fluid circuit to reduce vacuum that would otherwise occur as liquid is drawn down.

30. The apparatus of claim 26 wherein the priming system further comprises a flow control mechanism permitting gas to discharge through the second fluid circuit.

31. The apparatus of claim 26 wherein the second fluid circuit originates in proximity to the fluid dispenser and discharges gas into the reservoir.

32. The apparatus of claim 26 wherein the second fluid circuit originates in proximity to the fluid dispenser and discharges gas outside of the apparatus.

33. The apparatus of claim 26 further comprising a valve that controls the flow of liquid from the reservoir to the fluid circuit.

34. The apparatus of claim 33 wherein the valve prevents liquid from flowing from the fluid circuit to the reservoir section.

35. The apparatus of claim 26 wherein drawing liquid through the fluid circuit causes the reservoir to collapse such that substantially no vacuum space is created by voiding the liquid.

36. The apparatus of claim 26 wherein the priming system further comprises collapsing the reservoir to squeeze air out of the fluid circuit.

37. A method for heating a fluid within a feeding system comprising the acts of:
conveying liquid from a fluid reservoir through a first fluid circuit to a liquid dispenser;
heating the liquid in the first fluid circuit; and
evacuating air bubbles in the first fluid circuit through a second fluid circuit.

38. The method of claim 37 further comprising the act of replacing liquid drained from the reservoir with air by allowing air to flow into the reservoir through a third fluid circuit.

39. The method of claim 37 further comprising the act of collapsing a reservoir lining disposed within the fluid reservoir to expel liquid contained within the reservoir through the first fluid circuit to a liquid dispenser.

40. The method of claim 39 whereby the act of collapsing the reservoir lining further comprises displacing a first concentric shell containing the reservoir relative to a second concentric shell attached to the dispenser.

41. The method of claim 38 wherein the reservoir lining is collapsed by gravity.

42. The method of claim 38 wherein the reservoir lining is collapsed by suction.

43. The method of claim 37 whereby the air bubbles are evacuated through the second fluid circuit into the fluid reservoir.

44. The method of claim 43 whereby the flow of fluid from the reservoir to the second fluid circuit is prevented by a flow restriction device.

45. The method of claim 37 whereby air passing from the first fluid circuit through the second fluid circuit is evacuated to the outside.

46. The method of claim 45 whereby flow of outside air into the feeding system through the second fluid circuit is prevented by a flow restriction device.

47. The method of claim 38 where a flow restriction device prevents flow of liquid from the reservoir through the third fluid circuit.

48. A charging station for a thermal energy storage unit of a liquid feeding system comprising:
a heating pad for supplying heat energy to the thermal energy storage unit;
a power supply that is coupled to the heating pad the power supply providing energy to the heating pad; and
a base containing the power supply.

49. The charging station of claim 48 wherein the base comprises a mating thread that mates with a thread on a housing of an infant feeding system.

50. The charging station of claim 48 further comprising a controller that is coupled to the power supply.

51. The charging station of claim 50 wherein the controller further comprises a temperature controller for determining when the thermal energy storage unit is fully charged.

52. The charging station of claim 51 wherein the thermal energy storage unit further comprises a phase change material.

53. The charging station of claim 52 wherein the controller determines when the phase change material in the thermal energy storage unit has reached a liquid state.

54. The charging station of claim 48 wherein the thermal energy storage unit further comprises a phase change material.
